(19) United States
(12) Patent Application Publication
(10) Pub. No.: US 2015/0088622 A1
(43) Pub. Date: Mar. 26, 2015

(54) SOCIAL MEDIA APPLICATION FOR A MEDIA CONTENT PROVIDING PLATFORM

(71) Applicant: LiveOne, Inc., Chicago, IL (US)

(72) Inventor: Tim Ganschow, Chicago, IL (US)

(73) Assignee: LIVEONE, INC., Chicago, IL (US)

(21) Appl. No.: 14/390,949

(22) PCT Filed: Mar. 15, 2013
(86) PCT No.: PCT/US13/32280

§ 371 Date: Oct. 6, 2014

Related U.S. Application Data
(60) Provisional application No. 61/621,246, filed on Apr. 6, 2012.

(51) Int. Cl. H04L 12/18; G06Q 30/02; G06F 3/0482; G06F 17/30; G06F 3/0481; H04L 12/58

(52) U.S. Cl. CPC H04L 12/1813; G06F 3/04817; H04L 51/046; G06F 3/0482; G06F 17/30864; G06Q 30/0252
USPC 705/14.5; 715/716; 707/722; 707/736; 709/204

(57) ABSTRACT

A social media application for a media content providing platform for interaction and communication between and among audience members concerning the media content. The social media application includes a graphical user interface having a crowd representation section for providing a virtual crowd experience through visual representations of audience members attending the event. Accordingly, the social media application permits a user to review profile information associated with other audience members and communicate with audience members concerning the media content being displayed, in real-time. The social media application permits the media content provider to communicate with audience members, and to obtain information about the audience members.

### CROSS REFERENCE TO RELATED APPLICATION

This application claims the benefit of U.S. provisional application No. 61/621,246 filed on Apr. 6, 2012, which is incorporated by reference in its entirety.

### FIELD

The present invention relates to a social media application, in particular, an application permitting real-time user interaction at a media content provider platform.

### BACKGROUND OF INVENTION

Delivery of media content can be accomplished over the internet or by cable, satellite, and antenna communications including television programming, movies, video streaming, radio and music. Experiencing media content and communicating with other individuals concerning the media content is preferable and provides an enjoyable experience. Oftentimes, however, an individual is unable to be accompanied by other individuals and is relegated to watching or listening to media programming alone.

Media content providing platforms including third party streaming web sites hope to attract users by hosting various types of media content. These web sites, however, fail to provide an adequate interface permitting user communication and interaction and do not provide additional incentive for a user to experience the media content at the web site. This arrangement, therefore, fails to enhance the user experience or promote web site traffic to the site hosting the media content.

Some social media applications create interactive environments where individuals congregate. These environments, however, are specially-created web sites and do not drive traffic to the media content providing platform. Similarly, many of these specifically-created environments are populated with user-generated avatars. These functional avatars are bulky and difficult to be quickly scanned and scaled during a live event.

External third party communication applications, such as YAHOO MESSENGER application, AOL INSTANT MESSENGER application, or GOOGLE GMAIL chat program can be used to communicate over the internet. These applications, however, do not provide a direct communication link between individuals and various media content. These external communication applications are not implemented directly at the media content providing platform and it is therefore difficult for individuals to interact and communicate during the media content. Further, these external communication applications do not allow media content providers to leverage the audience experience to gather information about the audience or include advertisements targeted to a specific live audience.

### SUMMARY OF INVENTION

The present invention relates to a social media application for media content providing platforms including web sites, cable or satellite programming, radio, newspaper or other internet programming. Preferably, the social media application is used at media content providing platforms hosting live media content.

A plug-in application, including source code or other computing instructions for implementing the social media application, is hosted at a central server. Media content providing platforms can request access to the plug-in application at the central server for loading the plug-in application at the media content providing platform. Accordingly, users log into the social media application and experience the provided media content along with others logged into the application.

The social media application permits users to interact and communicate with other audience members regarding the displayed media content. The social media application includes a graphical user interface, preferably displayed toward a lower portion of the display, having a crowd representation section depicting a visual representation of audience members experiencing the live event. The crowd representation can include a plurality of audience icons represented logged in audience members and advertising indicia, such as that associated with sponsors of the live event.

The user can view profile information associated with other audience members at the social media application. By clicking on an audience icon within the crowd representation section, the graphical user interface provides a profile interface displaying profile information associated with the audience member. The profile information can include an uploaded picture and a variety of other information including, for example, topics such as: High School, College, Favorite Artist, Favorite Sports Teams, Favorite Concert Memory, Favorite Sports Memory, and so on. Information contained in an audience profile, of course, is customizable as desired or according to the media content being consumed.

The user can communicate with audience members through messaging. When viewing an audience profile, the user can enter a message at a dialogue box. Alternatively, the graphical user interface can provide a message input interface for managing messaging with audience members. This allows the individual to carry on multiple messaging conversations with various audience members. Additionally, the message input interface can permit group messaging with two or more audience members. The graphic user interface can also provide a message display portion showing multiple messages being transmitted by the crowd. The media content provider or advertiser can also communicate with audience members through messaging.

The social media application can present a variety of advertising indicia and advertisements for audience viewing and selection. For example, advertising indicia can be embedded or “crowd seeded” within the crowd representation section adjacent the plurality of audience icons. An audience member's selection of the advertising indicia can result in an advertisement filling the 970 pixel×250 pixel display area of the social media application, the audience icons of the crowd representation section, and other display portions.

The advertising indicia can also be an embedded sponsored profile within the crowd representation section. The embedded sponsor profile can be displayed adjacent the plurality of audience icons and can be a visually rich profile containing images, video presentation, and other media. Page scrolling to access additional advertisement can also occur. Accordingly, when clicked on by the user, the graphical user interface will display a depiction of the advertisement allowing user scrolling to view the advertisement.

A banner advertisement can also be posted at the social media application. The banner advertisement can have a size of 300 pixels wide by 250 pixels high that is prominently displayed toward and end location of the social media application. A text advertisement can also be displayed when viewing an audience member profile at a location adjacent the profile information.

The user data and activity at the social media application can be monitored and sent to the central server for processing and storage. Accordingly, user activity concerning the type of media content experienced, the duration of the user's logged in activity, and the type of advertisements viewed or selected can be tracked and recorded at the central server. This valuable data can be processed and used to generate analysis reports concerning the compiled user data and activity.

The following are examples of various embodiments of the social media application described herein.

Embodiment 1 is directed to a processor implemented method for creating a simulated crowd experience comprising the processor-implemented steps of: (A) storing a crowd-simulation plug-in application on a storage medium; (B) receiving a communication query from a content provider requesting access to the crowd-simulation plug-in application; (C) associating the crowd-simulation plug-in application with a first live event in response to the communication query; (D) providing the crowd-simulation plug-in application to a content provider for display on a visual medium; and (E) receiving audience-provided data during the first live event in real-time; wherein the crowd-simulation plug-in application includes virtual representations of one or more audience members experiencing the first live event.

Embodiment 1(a) is directed to the processor-implemented method of embodiment 1, wherein the data includes profile information of one or more audience member experiencing the first live event.

Embodiment 1(b) is directed to the processor-implemented method of embodiment 1 or 1(a), wherein the data includes messages between two or more audience members experiencing the first live event.

Embodiment 1(c) is directed to the processor-implemented method of any one of the embodiments 1-1(b), wherein the crowd-simulation plug-in application further includes advertisement indicia accessible by audience-members during the first live event.

Embodiment 1(d) is directed to the processor-implemented method of any of embodiments 1-1(c), wherein the data includes advertisement-access information for one or more audience member experiencing the first live event.

Embodiment 1(e) is directed to the processor-implemented method of any one of embodiments 1-1(d), wherein the data includes time-stamp information indicating when advertisement indicia was accessed by audience members.

Embodiment 1(f) is directed to the processor-implemented method of any one of embodiments 1-1(e), wherein the crowd-simulation plug-in is provided for display on a third-party website.

Embodiment 1(g) is directed to a system comprising one or more computers and one or more storage devices storing instructions that are operable, when executed by the one or more computers, to cause the one or more computers to perform the operations of the steps of any one of embodiments 1-1(f).

Embodiment 2 is directed to a graphic user interface for simulating a crowd experience, the interface comprising: a visual representation of a virtual crowd experiencing a real-time event; the virtual crowd comprising audience icons of a plurality of audience members; individual profile information associated with one or more of the audience icons wherein the individual profile information is accessible by selecting the corresponding audience icon; an input interface for receiving user-messaging; a dialogue board for displaying user-messaging; a series of menu buttons selectable by users; and advertisement indicia selectable by users; whereby a plurality of users interact with the virtual crowd during the live event.

Embodiment 2(a) is directed to the graphic-user interface of embodiment 2, wherein the interface has a rectangular shape having a size of about 970 pixels wide by 250 pixels high.

Embodiment 2(b) is directed to the graphic-user interface of embodiment 2 or 2(a), wherein the audience icons have a square shape having a size of about 50 pixels by 50 pixels.

Embodiment 2(c) is directed to the graphic-user interface of any one of embodiments 2-2(b), wherein the audience icons are arranged in a rectangular pattern being 13 icons wide and 4 icons high.

Embodiment 2(d) is directed to the graphic-user interface of any one of embodiments 2-2(c), wherein the audience icons are arranged in a rectangular pattern being 13 icons wide and 5 icons high.

Embodiment 2(e) is directed to the graphic-user interface of any one of embodiments 2-2(d), wherein the audience icons are arranged in a rectangular pattern being 19 icons wide and 5 icons high.

Embodiment 2(f) is directed to the graphic-user interface of any one of embodiments 2-2(e), wherein the audience icons are arranged in a rectangular pattern being 12 icons wide and 6 icons high.

Embodiment 2(g) is directed to the graphic-user interface of any one of embodiments 2-2(f), wherein the profile information includes information selected from the group consisting of hometown, birthday, college, favorite band, or a combination thereof.

Embodiment 2(h) is directed to the graphic-user interface of any one of embodiments 2-2(g), wherein the profile information is displayed within the graphic user interface.

Embodiment 2(i) is directed to the graphic-user interface of any one of embodiments 2-2(h), wherein the input interface is accessible by selecting an individual audience icon.

Embodiment 2(j) is directed to the graphic-user interface of any one of embodiments 2-2(i), wherein the input interface allows a user to post a message to the individual audience member represented by the selected audience icon.

Embodiment 2(k) is directed to the graphic-user interface of any one of embodiments 2-2(j), wherein the dialogue board displays user-messaging only to the individual audience member represented by the selected audience icon.

Embodiment 2(l) is directed to the graphic-user interface of any one of embodiments 2-2(k), wherein the dialogue board displays user-messaging to a group of audience members selected by the user.

Embodiment 2(m) is directed to the graphic-user interface of any one of embodiments 2-2(l), wherein the menu buttons are selected from the group consisting of statistics, roster, highlights, downloads, merchandise, friends, badges or a combination thereof.

Embodiment 2(n) is directed to the graphic-user interface of any one of embodiments 2-2(m), wherein the advertising indicia comprises a square shape placed within the audience icons and having a size of about 50 pixels by 50 pixels.

Embodiment 2(o) is directed to the graphic-user interface of any one of embodiments 2-2(n), wherein the advertising indicia transforms into a larger advertisement when selected by a user.

Embodiment 2(p) is directed to the graphic-user interface of any one of embodiments 2-2(o), wherein the advertising indicia transforms into a 970×250 pixel advertisement when selected by a user.

Embodiment 2(q) is directed to the graphic-user interface of any one of embodiments 2-2(p), wherein the larger advertisement conceals one or more audience icons.

Embodiment 2(r) is directed to the graphic-user interface of any one of embodiments 2-2(q), wherein the advertising indicia transforms into rich media when selected by a user.

Embodiment 2(s) is directed to the graphic-user interface of any one of embodiments 2-2(r), wherein the advertising indicia comprises a 300×250 pixel banner located proximate to the audience icons.

Embodiment 2(t) is directed to the graphic-user interface of any one of embodiments 2-2(s), wherein the advertising indicia comprises a text box displayed adjacent individual profile information.

Embodiment 2(u) is directed to the graphic-user interface of any of embodiments 2-2(s), wherein a location indicator is displayed on the audience icon of a first audience member and the location indicator provides information regarding the physical location of the first audience member.

Embodiment 2(v) is directed to the graphic-user interface of any of embodiments 2-2(u), wherein the physical location of the first audience member is automatically provided by monitoring the GPS coordinates of a mobile device associated with the first audience member.

Embodiment 3 is directed to a computer readable medium containing programming instructions for creating a simulated crowd experience, wherein execution of the program instructions by one or more processors of a computer causes one or more processors to carry out the steps of: (A) storing a crowd-simulation plug-in application on a storage medium; (B) receiving a communication query from a content provider requesting access to the crowd-simulation plug-in application; (C) associating the crowd-simulation plug-in application with a first live event in response the communication query; (D) providing the crowd-simulation plug-in application to a content provider for display on a visual medium; and (E) receiving audience-provided data during the first live event in real-time; wherein the crowd-simulation plug-in application includes virtual representations of one or more audience members experiencing the first live event.

Embodiment 4 is directed to a processor-implemented method for interacting with a simulated crowd comprising the processor-implemented steps of: (A) providing a visual representation of a virtual crowd experiencing a live event, wherein the virtual crowd comprises audience icons of a plurality of audience members; (B) storing profile information from at least one audience member; (C) obtaining confirmation of attendance at a live event from at least one audience member; (D) compiling a list of audience members in attendance at the live event to create a global audience population specific to the live event, wherein the list comprises profile information of each audience member in attendance; (E) creating a first limited audience population comprising audience icons and profile information from the global audience population; (F) creating a second limited audience population different from the first limited audience population.

Embodiment 4(a) is directed to the processor-implemented method of embodiment 4, wherein the first limited audience population comprises randomized profile information from the global audience population.

Embodiment 4(b) is directed to the processor-implemented method of embodiment 4 or 4(a), wherein the first limited audience population comprises profile information pre-selected from the global audience population based upon individual user preferences.

Embodiment 4(c) is directed to the processor-implemented method of any one of embodiments 4-4(b), wherein the second limited audience population comprises randomized profile information from the global audience population and different from the first limited audience population.

Embodiment 4(d) is directed to the processor-implemented method of any one of embodiments 4-4(c), further comprising creating additional limited audience populations comprising randomized profile information from the global audience population and different from the first and second limited audience population.

Embodiment 4(e) is directed to the processor-implemented method of any one of embodiments 4-4(d), wherein the second limited audience population comprises profile information filtered from the global audience population based upon a specific profile characteristic.

Embodiment 4(f) is directed to the processor-implemented method of any one of embodiments 4-4(e), wherein the specific profile characteristic is selected from the group consisting of age, location, college, favorite band, hometown, keyword or a combination thereof.

Embodiment 4(g) is directed to the processor-implemented method of any one of embodiments 4-4(f), wherein the first limited audience population comprises profile information from less than about 200 audience members.

Embodiment 4(h) is directed to the processor-implemented method of any one of embodiments 4-4(g), wherein the first limited audience population comprises profile information from greater than about 50 audience members.

Embodiment 4(i) is directed to the processor-implemented method of any one of embodiments 4-4(h), wherein the first limited audience population is represented by audience icons having a square shape with a size of about 50 pixels by 50 pixels.

Embodiment 4(j) is directed to the processor-implemented method of any one of embodiments 4-4(i), wherein the first limited audience population comprises randomized profile information from a subset of the global audience population.

Embodiment 4(k) is directed to the processor-implemented method of any one of embodiments 4-4(j), wherein the subset of the global audience population comprises a geographic region.

Embodiment 4(l) is directed to the processor-implemented method of any one of embodiments 4-4(k), wherein the additional limited audience populations are automatically created through randomized profile view refreshing.

Embodiment 4(m) is directed to the processor-implemented method of any one of embodiments 4-4(l), wherein the visual representation of the virtual crowd is displayed on a television screen.

Embodiment 5 is directed to a system comprising one or more computers and one or more storage devices storing instructions that are operable, when executed by the one or more computers, to cause the one or more computers to perform operations comprising: (A) storing profile information from at least one audience member; (B) obtaining confirmation of attendance at a real-time event from at least one audience member; (C) compiling a list of audience members in attendance at the real-time event to create a global audience population specific to the first real-time event, wherein the list comprises profile information of each audience member in attendance; (D) creating a first limited audience population comprising profile information from the global audience population; (E) creating a second limited audience population different from the first limited audience population.

Embodiment 5(a) is directed to the system of embodiment 5, wherein the audience-provided data is status indicia.

Embodiment 6 is directed to a processor-implemented method for inviting individuals to attend a live event in real-time comprising the processor-implemented steps of: (A) obtaining confirmation of attendance at a live event for at least one audience member; (B) prompting at least one audience member to invite an invitee to attend the live event, wherein the prompting occurs after commencement of the live event and while the live event is proceeding; (C) tracking the time when the at least one audience member sends an invitation to the invitee; (D) tracking the identity of the invitee based upon identifying-indica provided by the at least one audience member; (E) obtaining confirmation of attendance at the live event for the invitee within a count-down period; (F) providing notification to the at least one audience member that the invitee is in attendance at the real-time event.

Embodiment 6(a) is directed to the processor-implemented method of embodiment 6, wherein the prompting occurs at randomized time intervals during the occurrence of the live event.

Embodiment 6(b) is directed to the processor-implemented method of embodiment 6 or 6(a), wherein the prompting occurs in response to a triggering event that occurs during the live event.

Embodiment 6(c) is directed to the processor-implemented method of any one of embodiments 6-6(b), wherein the prompting occurs in response to an advertisement.

Embodiment 6(d) is directed to the processor-implemented method of any one of embodiments 6-6(c), wherein the identifying-indicia comprises an e-mail address of the invitee.

Embodiment 6(e) is directed to the processor-implemented method of of embodiments 6-6(d), wherein the identifying-indicia comprises a code provided to the at least one audience member to convey to the invitee.

Embodiment 6(f) is directed to the processor-implemented method of embodiments 6-6(e), wherein the countdown period is a period of time communicated to the at least one audience member to convey to the invitee.

Embodiment 6(g) is directed to the processor-implemented method of embodiments 6-6(f), wherein the notification further comprises granting a reward to the at least one audience member.

Embodiment 6(h) is directed to the processor-implemented method of embodiments 6-6(g), wherein the reward is provided to the at least one audience member by a media-distribution sponsor of the live event.

Embodiment 6(i) is directed to the processor-implemented method of embodiments 6-6(h), wherein the reward is provided to the at least one audience member by the content-creator of the live event.

Embodiment 6(j) is directed to the processor-implemented method of embodiments 6-6(i), wherein the content creator is an entertainer.

Embodiment 6(k) is directed to a system comprising one or more computers and one or more storage devices storing instructions that are operable, when executed by the one or more computers, to cause the one or more computers to perform the operations of the steps of embodiments 6-6(j).

Embodiment 7 is directed to a processor-implemented method for interactive advertising during a live event in real-time comprising the processor-implemented steps of: (A) providing a visual representation of a virtual crowd experiencing a live event, wherein the virtual crowd comprises audience icons of a plurality of audience members; (B) storing profile information from at least one audience member; (C) providing advertisement indicia selectable by audience members; wherein the advertisement indicia is embedded within the virtual crowd alongside audience icons; and (D) monitoring parameter of advertisement selection of audience members during the live event in real time.

Embodiment 7(a) is directed to the processor-implemented method of embodiment 7, wherein the parameter being monitored is selected from the group consisting of start-time, duration of access, frequency of access, related-advertisements accessed and a combination thereof.

Embodiment 7(b) is directed to the processor-implemented method of embodiment 7 or 7(a), wherein parameter being monitored is cross-referenced to the events occurring during live event.

Embodiment 7(c) is directed to the processor-implemented method of embodiments 7-7(b), further comprising compiling a histogram referencing parameter of advertisement selection cross-referenced to time stamp of live event.

Embodiment 7(d) is directed to the processor-implemented method of embodiments 7-7(c), wherein the parameter being monitored is cross-referenced to profile information of at least one audience member.

Embodiment 7(e) is directed to the processor-implemented method of embodiments 7-7(d), further comprising prompting at least one audience member to select advertisement indicia within a count-down period, tracking the time when the at lest one audience member selects advertisement indicia, and granting a reward to the at least one audience member in response to selection of advertisement indicia.

Embodiment 7(f) is directed to a system comprising one or more computers and one or more storage devices storing instructions that are operable, when executed by the one or more computers, to cause the one or more computers to perform the operations of embodiments 7-7(e).

Embodiment 8 is directed to a computer architecture for managing data related to a simulated crowd experience, the architecture including: at least one plug-in application server comprising data and programming instructions for generating a graphic user interface for simulating a crowd experience wherein the programming instructions are accessible by a third-party content provider platform; at least one registration server comprising a database for new audience member registration and audience member profile information; at least one event-data tracking server for monitoring and storing data related to audience-member activities occurring during an event; at least one messaging server for managing receipt and dissemination of audience-member messaging and invitations; at least one media server for managing dissemination of media, including advertising; at least one audience population filter server for managing a global audience population and filtering the global audience population into a limited audience population; wherein at least one of the servers is linked for network communications with a third-party.

Embodiment 8(a) is directed to the computer architecture of embodiment 8, wherein the architecture is for providing social experiences relating to media content at a plurality of third-party content providers.

Embodiment 9 is directed to a processor-implemented method for inviting individuals to attend a live event in real-time comprising the processor-implemented steps of: (A) obtaining confirmation of attendance at a live event from a first audience member; (B) obtaining individual profile information related to the first audience member; (C) inviting additional invitees to attend the live event based upon the individual profile information associated with the first audience member; (D) providing notification to the first audience member that the invitee is in attendance at the real-time event.

### BRIEF DESCRIPTION OF THE DRAWINGS

The drawings include:

FIG. 1A is a screen shot view of a social media application of the current invention at a content providing platform;

FIG. 1B is a screen shot view of the social media application at a content providing platform displayed on a tablet device;

FIG. 1C is a screen shot view of the social media application at a content providing platform displayed on a mobile phone device;

FIG. 1D is a screen shot view of the social media application at a content providing platform displayed on a personal computer device;

FIG. 1E is a screen shot view of the social media application at a content providing platform displayed on a television;

FIG. 2 is a block diagram of a social media server and third party media content hosting platform;

FIG. 3 is a flow diagram illustrating the social media server communicating with third party media content hosting platform;

FIG. 4 is a block diagram of third party media content hosting platform displaying different media content at the same time to separate audiences;

FIG. 5 is a block diagram of third party media content hosting platforms displaying the same media content with shared audiences;

FIG. 6 is a block diagram of third party media content hosting platforms displaying different media content and third party media content hosting platforms displaying the same media content, both at the same time;

FIG. 7 is a partial screen shot view of the social media application;

FIG. 8 is a screen shot view of an alternative embodiment of the social media application;

FIG. 9A is a front view of one embodiment of the social media application;

FIG. 9B is a front view of another embodiment of the social media application;

FIG. 9C is a close-up view of the horizontal social media application;

FIG. 9D is a front view of an embodiment of the social media application;

FIG. 9E is a front view of another embodiment of the social media application;

FIG. 9F is a front view of an alternative embodiment of the social media application;

FIG. 9G is a front view of an alternative embodiment of the social media application;

FIG. 9H is a front view of a graphical user interface at the social media application;

FIG. 9I is a front view of an alternative graphical user interface at the social media application;

FIG. 9J is a front view of an alternative graphical user interface at the social media application;

FIG. 9K is a front view of an alternative graphical user interface at the social media application;

FIG. 10 is a flow diagram illustrating an account registration routine for the social media application;

FIG. 11 is a flow diagram illustrating a login routine for the social media application;

FIG. 12 is a screen shot view of the login section for the social media application;

FIG. 13 is a flow diagram illustrating an anonymous registration routine for the social media application;

FIG. 14 is a screen shot view of the profile section of the social media application;

FIG. 15 is a flow diagram illustrating a profile selection routine for the social media application;

FIG. 16 is a screen shot view of the concert tab of the profile section of the social media application;

FIG. 17 is a screen shot view of the friends tab of the profile section of the social media application;

FIG. 18 is a screen shot view of the badges tab of the profile section of the social media application;

FIG. 19 is a screen shot view of a message section of the social media application;

FIG. 20 is a block diagram depicting embodiments of the social media application;

FIG. 21 is a screen shot view of a search section of the social media application;

FIG. 22 is a screen shot view of a share section of the social media application;

FIG. 23 is a screen shot view of a settings section of the social media application;

FIG. 24 is a screen shot view of a customizable menu section of the social media application;

FIG. 25 is a flow diagram of an advertisement routine for the social media application;

FIG. 26A is a front view of the social media application and an embedded advertisement;

FIG. 26B is a front view of the social media application and an embedded sponsored profile advertisement;

FIG. 26C is a front view of the social media application and a banner advertisement;

FIG. 26D is a front view of the social media application and the banner advertisement of FIG. 16C in collapsed form;

FIG. 26E is a front view of a profile of the social media application and a text advertisement;

FIG. 26F is a front view of an advertisement dashboard;

FIG. 27 is a flow diagram of a crowd representation routine for the social media application;

FIG. 28 is a flow diagram of a real-time invitation routine for the social media application;

FIG. 29 is a block diagram depicting social media servers and the social media application at a media content providing platform;

FIG. 30 is a block diagram depicting social media servers and the social media application at a media content providing platform for display at computing devices;

FIG. 31 is a block diagram illustrating a registration process for the social media application;

FIG. 32 is a front view of an advertising embodiment associated with the social media application;

FIG. 33 is a front view of another advertising embodiment associated with the social media application;

FIG. 34 is a front view of a tablet computing device depicting an advertising embodiment associated with the social media application;

FIG. 35 is a front view of a mobile computing device depicting an advertising embodiment associated with the social media application;

FIG. 36 is a front view of a tablet computing device depicting another advertising embodiment associated with the social media application;

FIG. 37 is a front view of another advertising embodiment associated with the present invention;

FIG. 38 is a screen shot view of an embodiment of the social media application;

FIG. 39 is a screen shot view of an embodiment of the social media application;

FIG. 40 is a flow diagram illustrating a group invitation routine for the social media application;

FIG. 41 is a flow diagram illustrating a physical location utilization routine for the social media application.

### DETAILED DESCRIPTION

In the following description, certain specific details are set forth in order to provide a thorough understanding of the various embodiments of the invention. However, upon reviewing this disclosure one skilled in the art will understand that the invention may be practiced without many of these details. In other instances, well-known or widely available material has not been described in detail to avoid unnecessarily obscuring the descriptions of the embodiments of the invention.

The present invention is a social media application that provides a virtual crowd experience that approximates the experience of attending live events such as music concerts, sports, political events, and other cultural events. Similar to attending a live concert, for example, the social media application of the present invention provides an interactive experience for communicating among other attendees and friends concerning the music, the band, or the general impressions about the concert. The social media application of the present invention can also provide an interactive experience for persons reading the same online newspaper or periodical on a network. As described below, the social media application approximates many aspects of attending an event in person.

For example, just as a concert-goer can focus his attention on existing friends by buying tickets and attending together, an embodiment of the social media application allows a user to invite existing friends to attend the event or participate at an exclusive communication space. Just as a concert-goer can meet new people at the event, the user of an embodiment of the social media application can meet and interact with strangers who share similar tastes through browsing audience profiles for specific characteristics. The global CROWDSURFING and messaging features of an embodiment of the social media application provide a virtual experience replicating the interacting and meeting one would experience at a live venue. The social media application can also capture and approximate the energy and size of the event by, for example, displaying an “audience meter” to indicate the number of audience members viewing the live content, or providing a streaming log of messages being transmitted by the global crowd. Staying true to real life, the user can avoid less desirable audience members by implementing security features limiting profile access or blocking messaging. Accordingly, the present invention aims to simulate a virtual environment replicating that of a live experience.

The invention disclosed herein is, of course, susceptible of embodiment in many forms. Shown in the drawings and described herein below in detail are the preferred embodiments of the invention. It is to be understood, however, that the present disclosure is an exemplification of the principles of the invention and does not limit the invention to the illustrated embodiments.

### General Architecture

The present invention relates to a social media application 100 for a media content providing platform 102. Several media content providing platforms 102 exist and can include web sites, cable, internet, antenna programming, radio wave programming or any other platform capable of hosting media content. For example, web sites 103, such as HULU, YOUTUBE, YAHOO, and so on, host various media content including video, images, and music. Oftentimes, media content can be hosted concurrently with a live event. In these situations, media content providing platforms desire to drive user traffic to the platform for viewing the live content.

The social media application 100 permits communication and interaction between audience members logged in at the media content providing platform 102. This provides a virtual environment for individual users to interact with others and helps drive user traffic to the media content providing platforms 102. Although many of the embodiments are described in the context of visual media content such as video or imaging, the application of the present invention is also applicable to audio-only media content such as speeches, concerts, radio or music. The application of the present invention is also applicable to visual-only media content such as newspapers, magazines, or other periodicals that can be viewed on-line by users. For example, audience members logged in at the media content providing platform 102 and viewing the same periodical at the same time as another user can communicate and interact with one another just as two users viewing the same concert or sporting event can interact with one another.

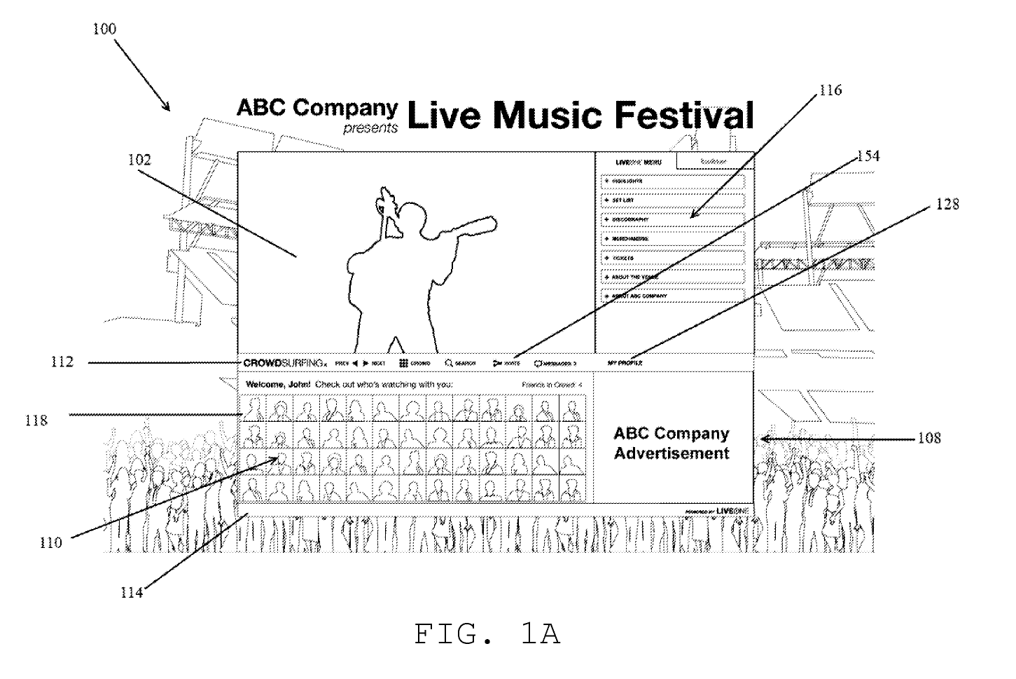

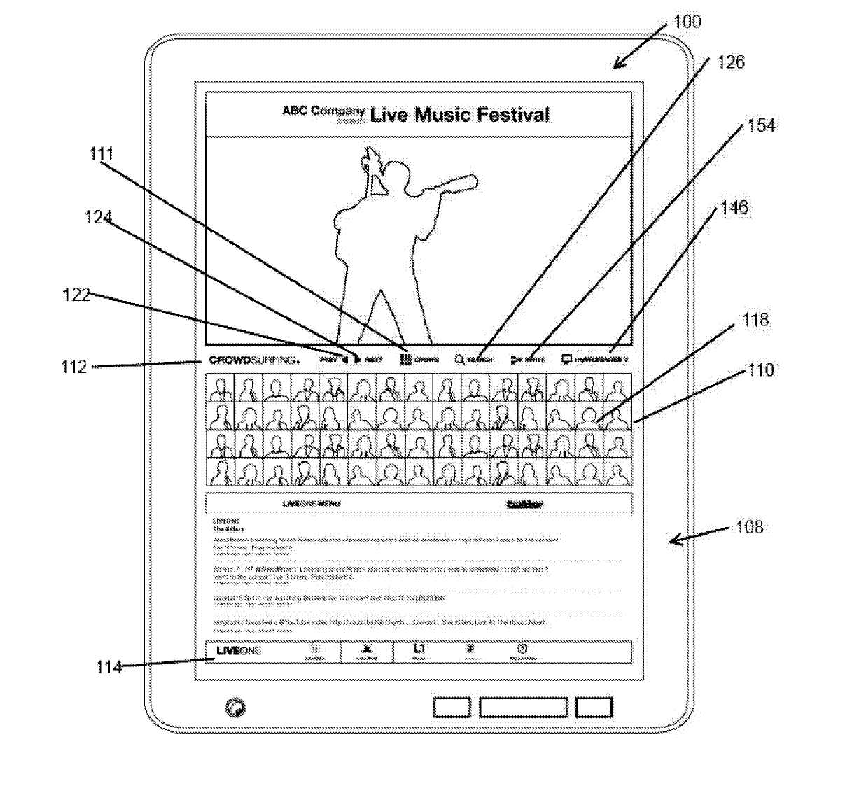

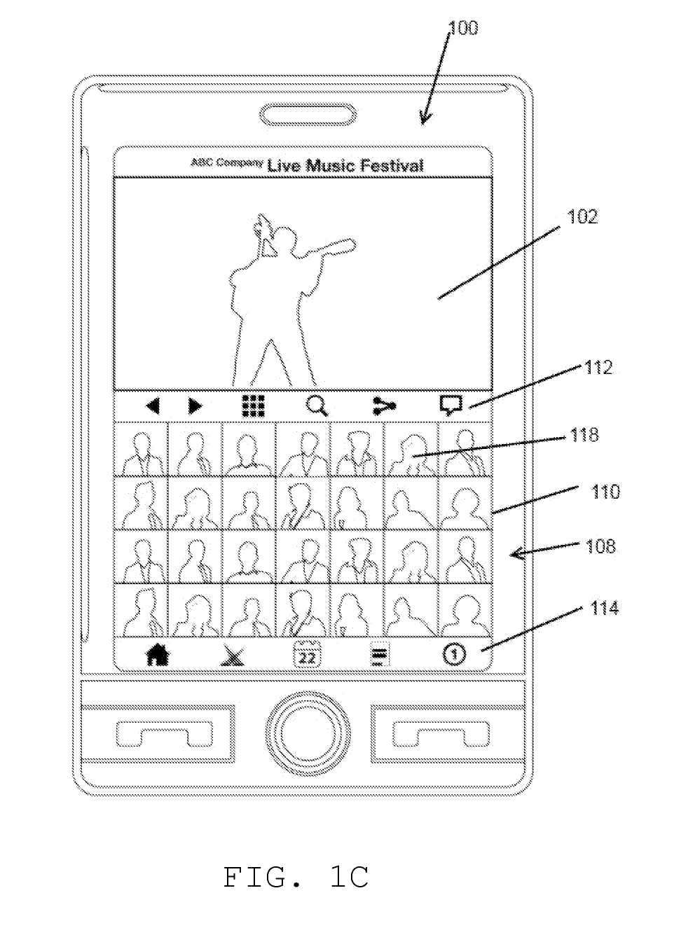

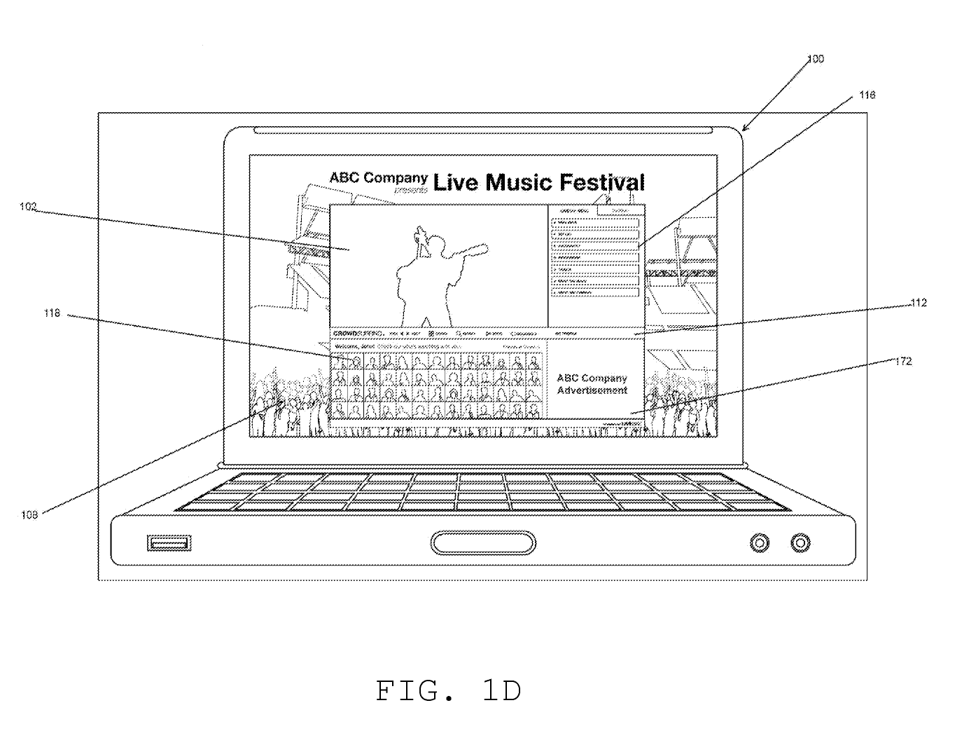

Referring to FIGS. 1A-1E, the social media application 100 is configured for display on various computing devices including mobile devices such as smartphones, tablets, laptops, televisions, and other personal computing devices. The social media application can be displayed generally toward the lower portion of the display screen so as to limit obstruction of the displayed media content. The media content is preferably a live event such as a sporting event, concert, political event or live television programming such as reality television or other reality contest show. Generally, live events help stimulate user interaction and discussion. Live event can refer to an event that is occurring in real-time as it is being experienced by the remote audience. Live event can also refer to events that are being broadcast or streamed live to an audience even if the media content has been recorded or taped at another time, such as with certain reality television programs, and standard television programming.

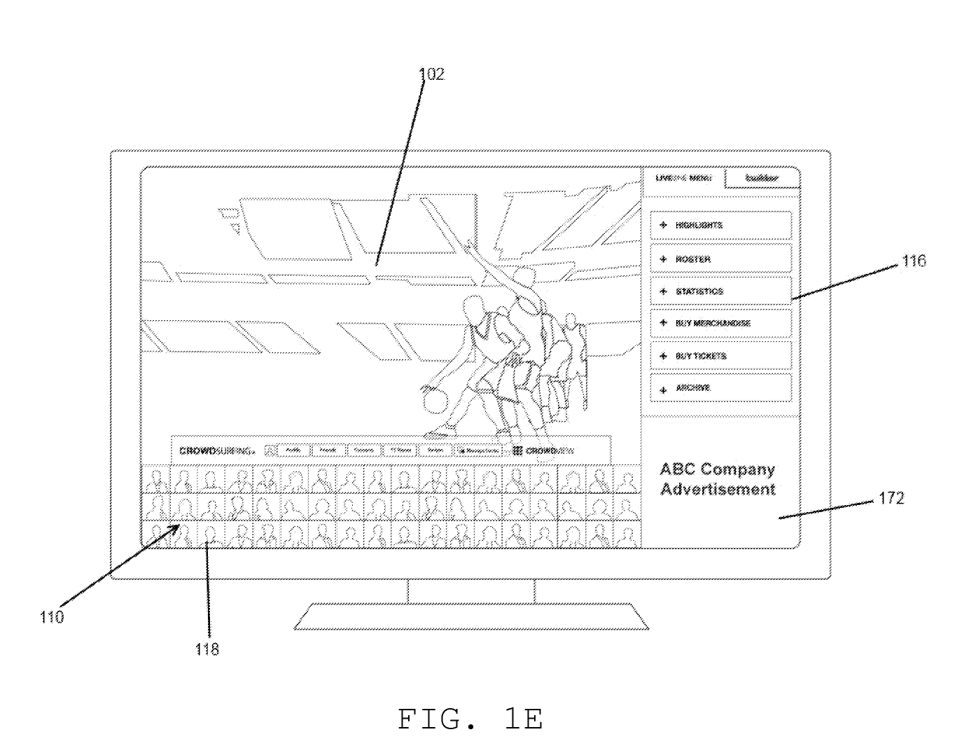

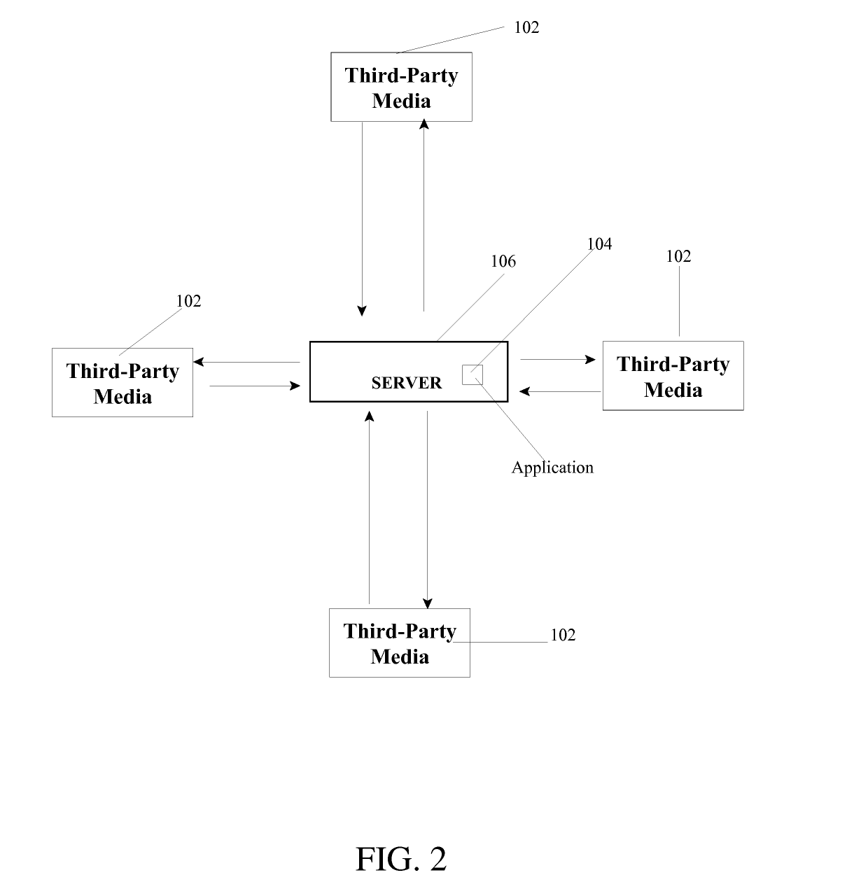

Referring to FIG. 2, the media content providing platform 102 communicates and exchanges information with a central internet server 106 such as an AMAZON EC2 webserver. Information relating to user activity including selection of advertisements, profiles, filtering of displayed audience members or other activity associated with the user's interaction at the social media application 100 can be transmitted between the server 106 and the social application 100 at the media content providing platform 102.

The social media application 100 can function with all major web browsers including, but not limited to, MOZILLA FIREFOX 3+ browser, GOOGLE CHROME 6+ browser, APPLE SAFARI 3+ browser, OPERA 9+ browser, and MICROSOFT INTERNET EXPLORER 7+. The social media application 100 is also adapted for major operating systems including, but not limited to, MICROSOFT WINDOWS XP/VISTA/7/8 operating system, APPLE MAC OSX 10.5+ operating system, and UBUNTU 9+ operating system. The social media application 100 will, of course, receive updates for configuration with other web browsers as those browsers update as well. New versions of the social media application 100 as well as specific customizations can be automatically pushed out to the relevant media content providing platforms. The social media application can also be implemented on typical televisions via, for example, APPLE TV system, ROKU system, or other smart televisions.

The social media application 100 can also be implemented to interface with separate applications or other platforms through application programming interfaces (“API”). This API feature enables third-party entities, such as software developers, to create and optimize applications of the current invention to meet specific requirements of a unique platform. Software Development Kits (“SDK”) of pre-written code associated with the social media application can also be developed concerning the social media application for developer use in implementing the present invention on content platforms.

### Providing Plug-In Application To Content Provider Platform

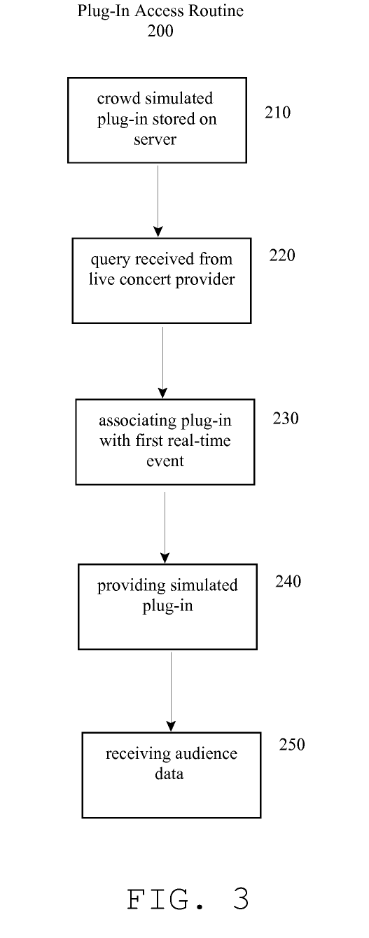

As illustrated in FIG. 3, plug-in access routine 200 demonstrates a crowd simulating plug-in application 104 for loading the social media application 100 onto media content providing platform 102. The crowd simulating plug-in application 104 includes source code or other computer implemented instructions and is stored 210 on the central server. Media content providing platform 102 can access the plug-in application 104 by transmitting a query to the central server 106. The server receives the query 220 and can associate the plug-in application with a first live event in response to the communication query 230. The server then provides the plug-in application to the media content providing platform where it implements the social media application for display 240 on a visual medium. The plug-in application 104 can be loaded on multiple media content providing platforms 102 for displaying different media content at the same time with distinct audiences for each of the media content as shown in FIG. 4. For example, the media content providing platform can copy and paste the html or other code to the source code associated with the platform thereby generating the embedded crowd application within their platform end-user environment. Once implemented, media content providing platform is capable of receiving audience-provided data, such as profile information or messages between two or more audience members, during the first real-time event 250.

As shown in the example at FIG. 4, the plug-in application 104 can be loaded onto four distinct websites. Although loaded with the same plug-in application, these distinct web sites can display different media content. As shown, the first website provides coverage of a first music concert, the second website shows a sporting event, the third website shows a different music concert, and the fourth website provides content to a gaming event. Each of the audiences, however, experiencing these events can be different.

Referring to FIG. 5, the plug-in application 104 can be loaded on multiple media content providing platforms 102 that display the same media content to the same audiences. For example, four distinct web sites 102 are hosting media content for the same music concert. Each of the four web sites provide the same media content and include the same audience.

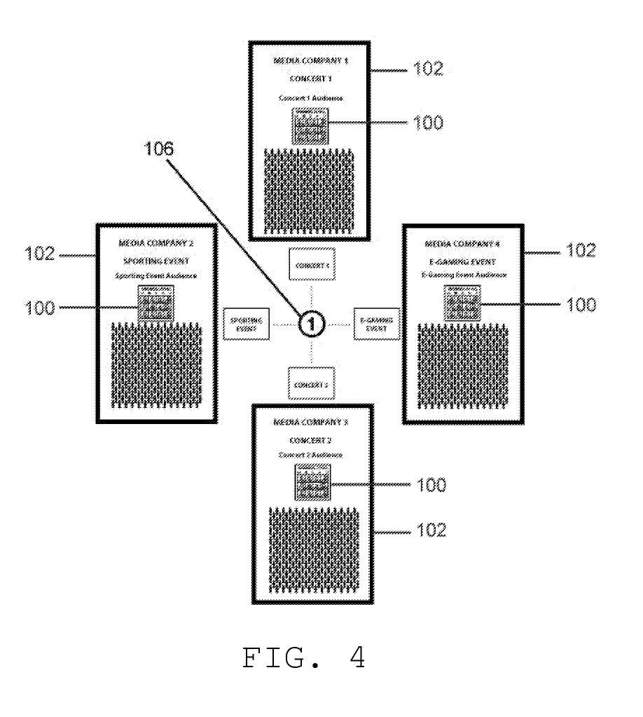

The plug-in application 104 is universal and provides for concurrent media presentation as shown in FIG. 6. For example, the plug-in application 104 can be loaded and implemented on both multiple media content providing platforms 102 having the same audience, such as the content being displayed on four distinct web sites, as shown in FIG. 4, and multiple media content providing platforms 102 providing the same content and having different audiences as shown in FIG. 5.

Referring to FIGS. 29-30, computer architecture associated with the present invention can manage data related to a simulated crowd experience. The architecture can include at least one plug-in application server for storing the plug-in application 104 and having data and programming instructions for generating the graphic user interface 108 for simulating a crowd experience wherein the programming instructions are accessible by a third-party content provider platform 102. At least one registration server can include a database for storing new audience member registration and audience member profile information and at least one event-data tracking server can be used for monitoring and storing data related to audience-member activities occurring during an event. At least one messaging server can manage receipt and dissemination of audience-member messaging and invitations during the event. In addition, at least one media server can manage dissemination of media such as advertising. At least one audience population filter server can manage a global audience population and randomize or filter the global audience population into a limited audience population for display at the social media application.

The servers can be linked for network communications with at least one third-party media content provider 102. As shown in FIG. 29, the computer architecture can provide social experiences relating to media content at a plurality of third-party content providers. In this example, Events 1-4 include individually distinct media content. Accordingly, the computer architecture provides for distinct social experiences (e.g. different audiences) concerning distinct media content presented plurality of third-party content providers. In another example, of course, Events 1-4 can be the same event encompassing the same media content. Similarly, users can experience Events 1-4 on various computing devices as depicting in FIG. 30.

Accordingly, this permits the central server 106 to function with multiple partners producing concurrent media content, such as sports leagues. For example, the NATIONAL FOOTBALL LEAGUE (“NFL”) organization can provide football game content having multiple distinct audiences at the same time on multiple distinct web sites. Individuals viewing a football game against two midwestern football teams may not want to be intermingled with people watching a second football game against two eastern football teams. Additionally, the first midwestern game could be hosted on both NFL.com website and FOXSPORTS.com website, for example, while the second eastern game could be hosted on NFL.com website and CBS.com website, for example. Accordingly, there would be a desire to have those two different sites sharing the same audience as they are both watching the same media content. Thus, delivering multiple distinct audiences on multiple sites while simultaneously delivering the same audience to multiple sites would be advantageous.

### Graphic User Interface Appearance

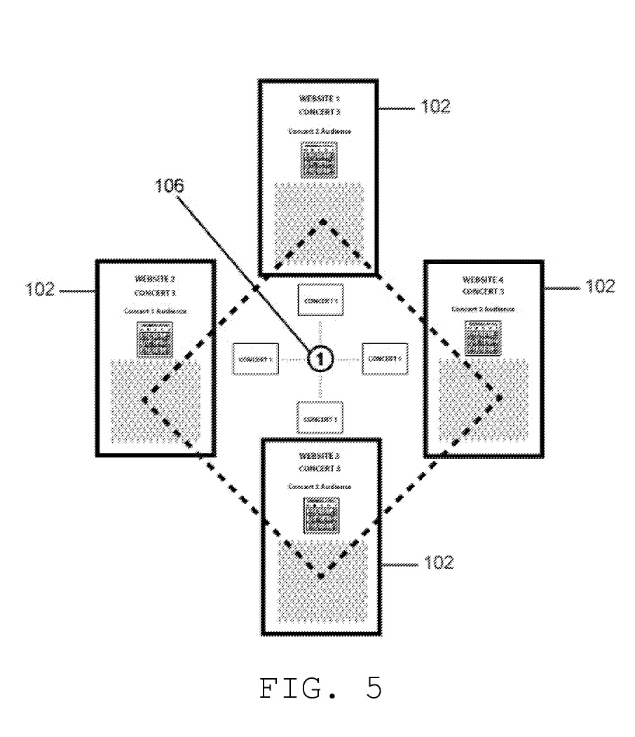

The social media application 100, depicted in FIGS. 7-9C, includes a graphical user interface 108 having a panel disposed at the display of a computing device. In the preferred embodiment, the graphical user interface 108 is generally rectangular and sized at 970 pixels wide by 250 pixels high and adapted to display various content associated with the social media application 100. For example, the graphical user interface 108 can be transformed to various input interfaces as selected by the user. The social media application 100 and graphical user interface 108 are designed so as to be in an easily viewable location at the display but so as to not obstruct viewing of the media content or to overwhelm the crowd with too much information. This efficient design and space-utilization increases the value of the audience experience.

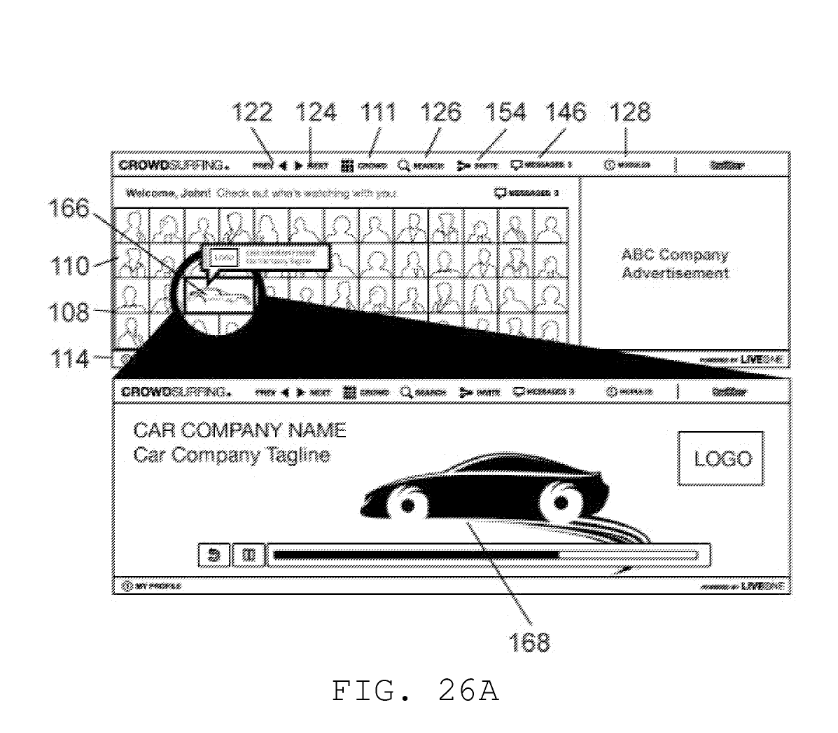

The scheme and style of the social media application 100 can also be changed as shown in FIG. 23, for example. The Color Scheme can be set to be various colors including, but not limited to Orange, Red, Purple, Blue or Green. Similarly, the settings can be adjusted for message settings. The user can turn the message tone or off. Security can also be adjusted to permit the user to receive messages from anyone or to limit who the user receives messages from. Accordingly, the user can limit messages, for example, from Friends Only or from Only People User Messages or other limits such as geographic location, age, or gender. The graphical user interface 108 can include a message display portion showing a streaming log of all messages being transmitted by the global crowd. A user can adjust the view to provide this type of message display to allow the user to obtain a general understanding and feel for the size and energy of the crowd, in much the same way an attendee at a live event would obtain this understanding by overhearing comments from the crowd in general.

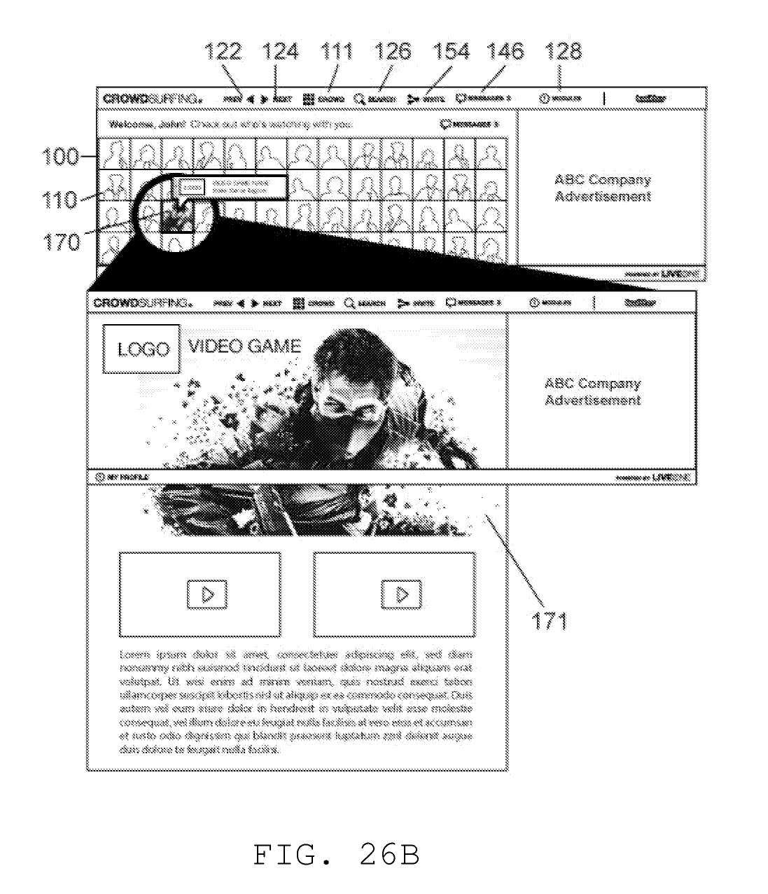

The user can also select options from the customizable menu 116 shown in FIG. 24. The customizable menu buttons can include categories including, but not limited to, statistics 156, roster 158, highlights 160, video downloads 162, tickets 165 and buy merchandise 164, for example. These options allow the users to view other content associated with the live event.

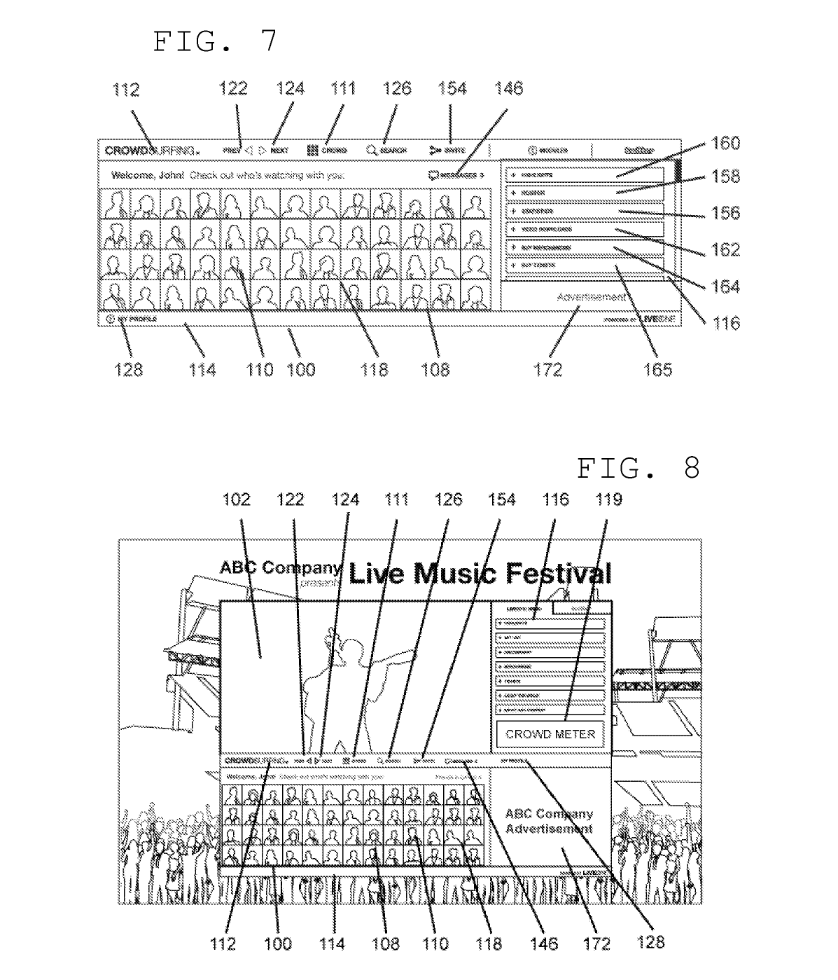

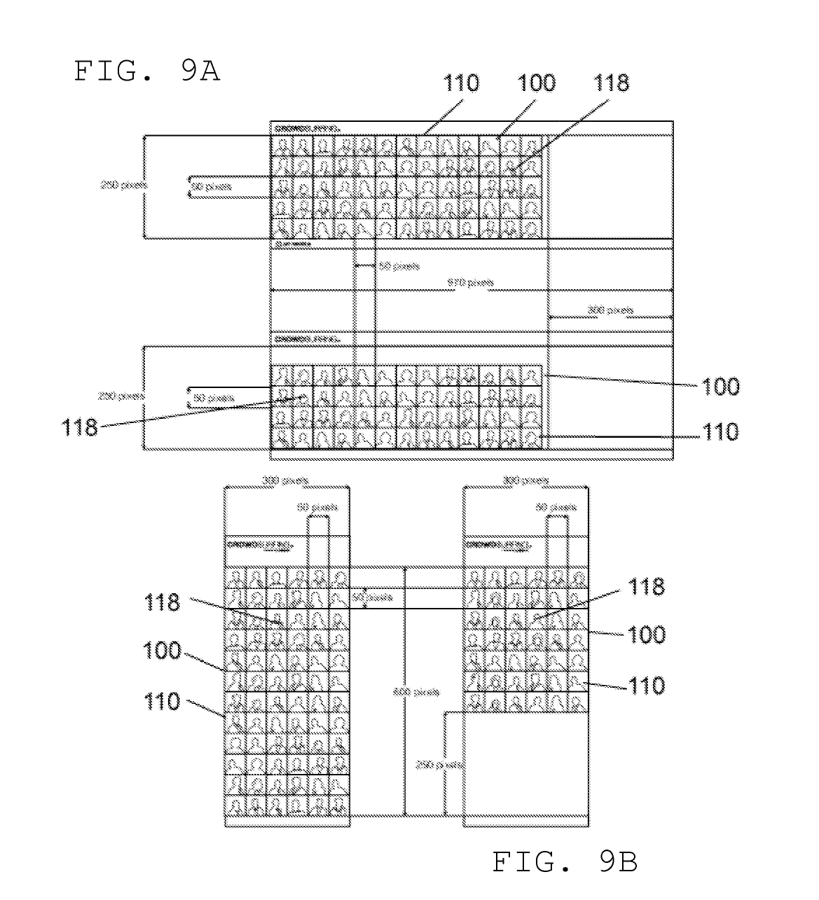

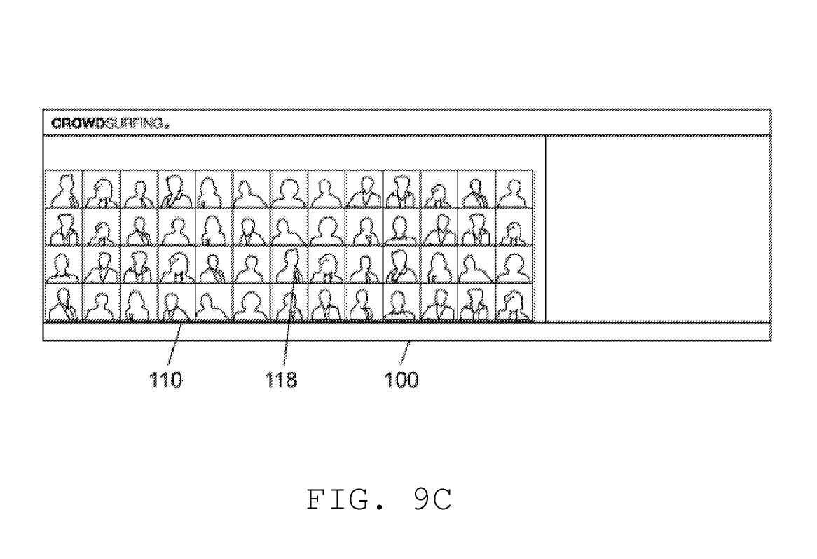

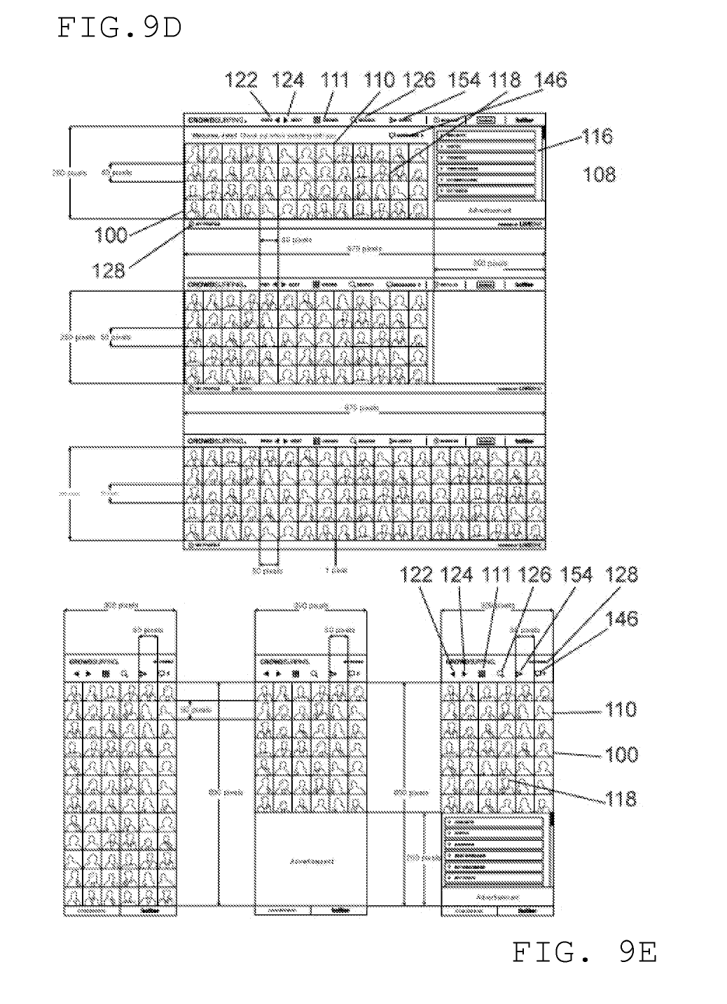

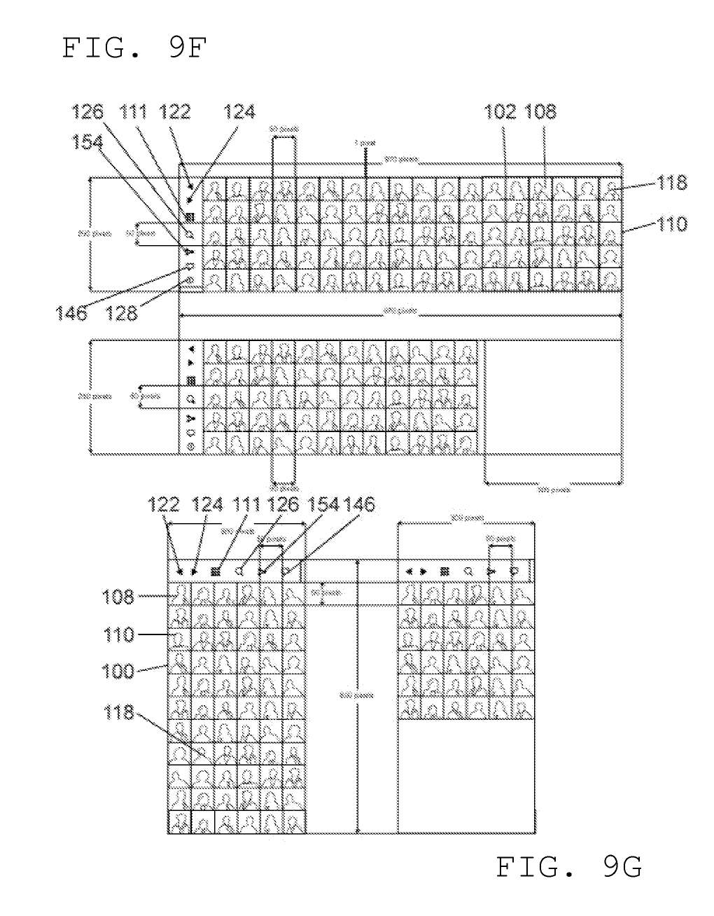

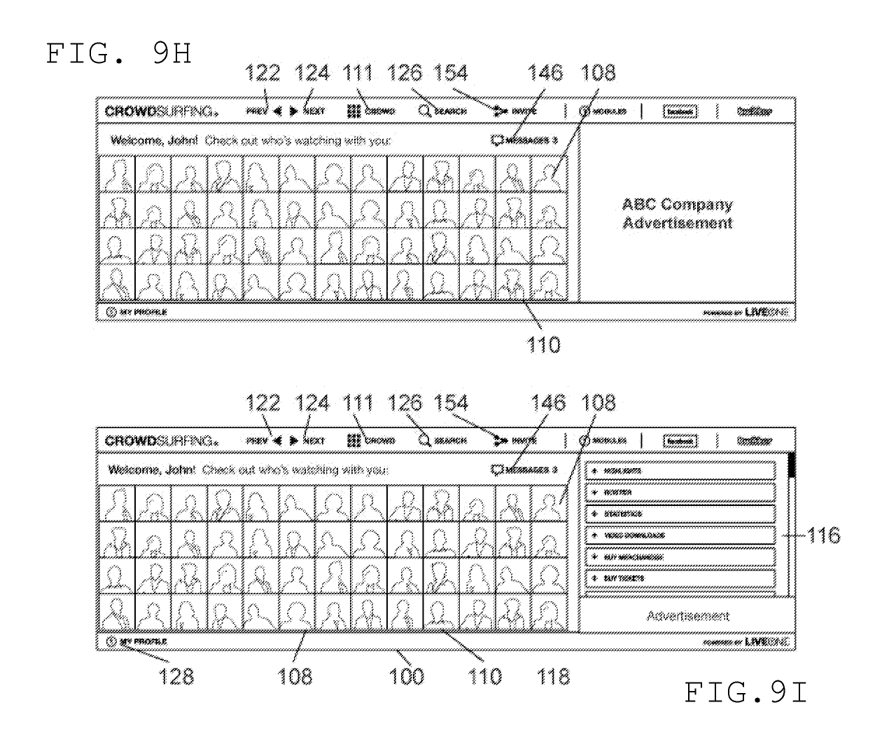

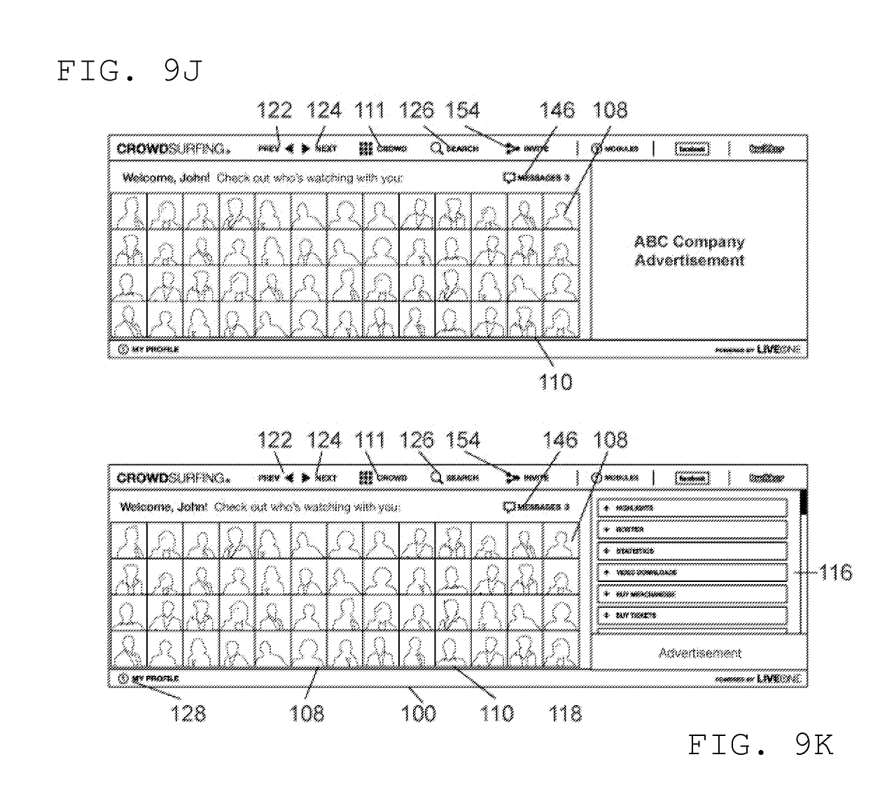

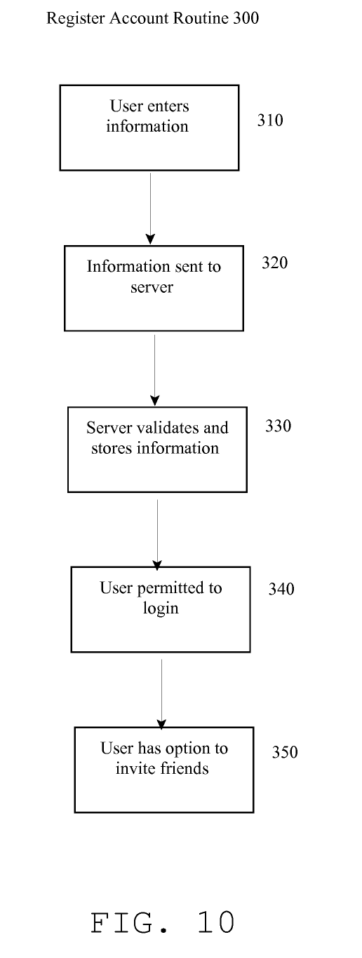

Referring to FIGS. 7, 9A and 9C, the graphical user interface 108 can include a default display comprising a crowd representation section 110, an upper tool bar 112, a lower tool bar 114, and a customizable menu 116 including a plurality of buttons. The graphical user interface 108 can also include various advertising indicia or advertisements.

The crowd representation section 110 can be a default display of the graphical user interface 108 but can also be accessed by selecting a button or a logo, such as the CROWDSURFING logo. A user can also select the “crowd” button 111 located at the upper tool bar 112 to view the most recently generated crowd representation section 110. The crowd representation section 110 includes a visual representation of a virtual crowd experiencing a live event. In general, the visual representation of the virtual crowd includes audience icons 118 of a plurality of audience members logged into the social media application 100. Individual profile information associated with the audience icons 118 can be accessed when the user selects the corresponding audience icon 118.

To allow a user to approximate the overall size of the virtual crowd experiencing the live event, an audience meter 119 can appear in the graphical user interface 108 to convey information about crowd size. This meter can have a variety of appearances, such as a simple numeric number, or a bar graph indicating the crowd size as the bar moves upward or downward along a numerical scale. The meter can have a more visceral appearance such as an icon that changes color (such as from yellow to red) to indicate growing crowd size, or an icon that pulses or blinks more quickly as the crowd size grows.

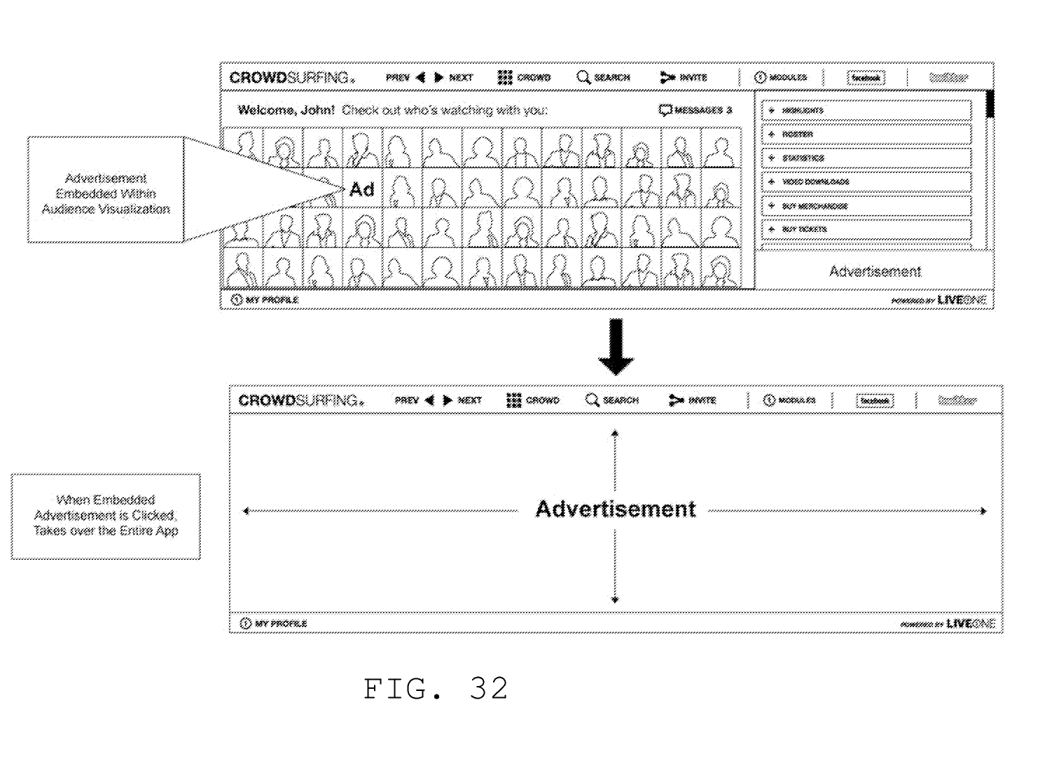

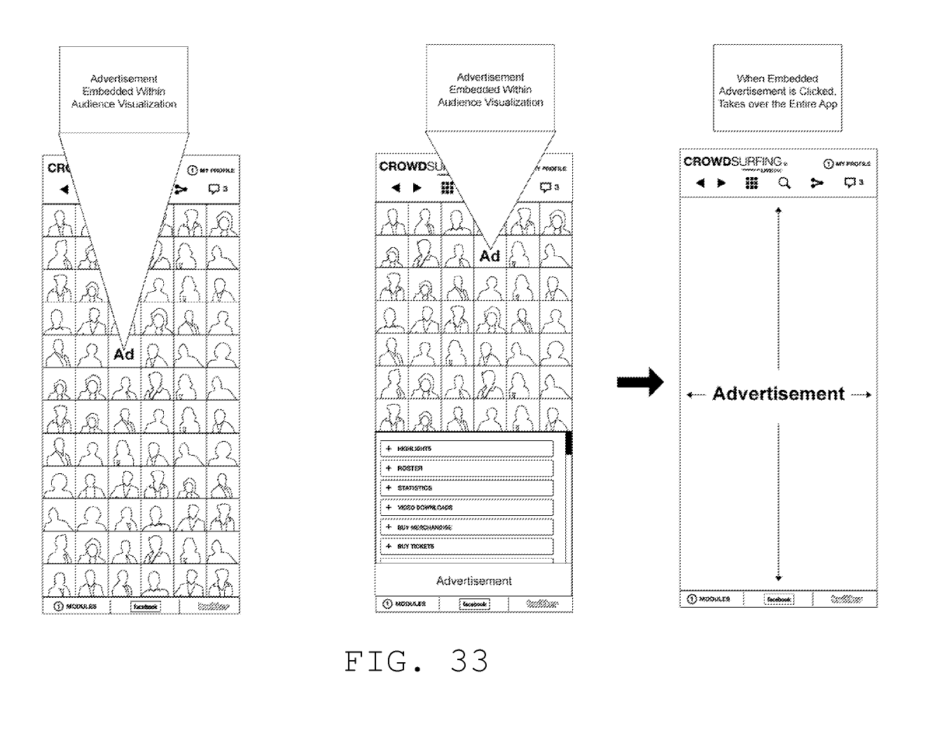

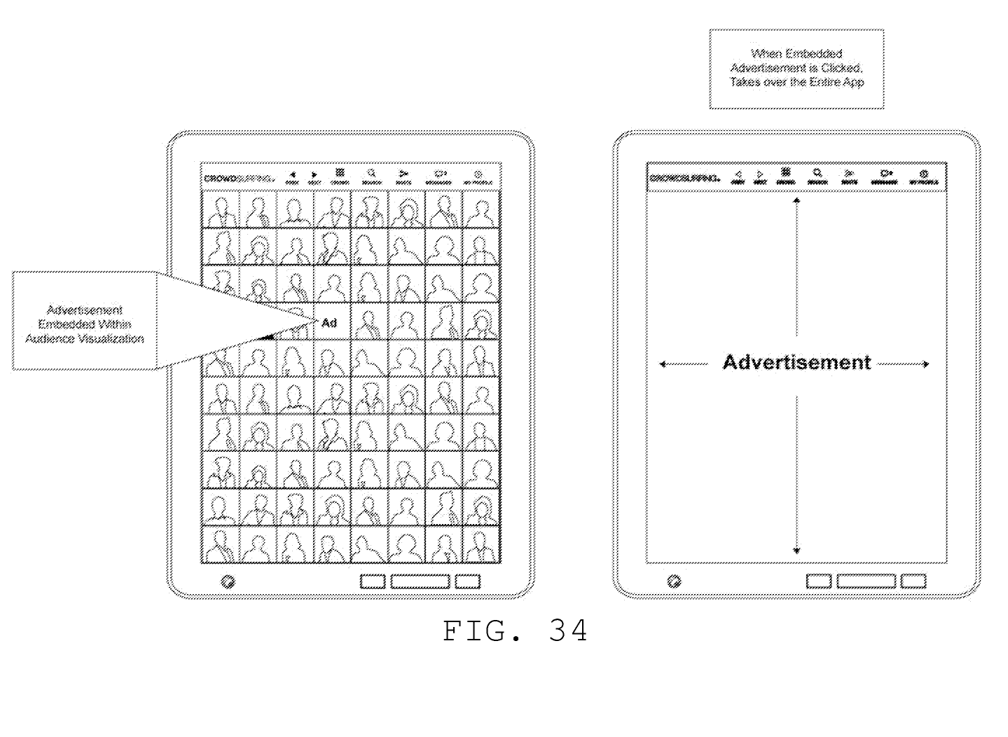

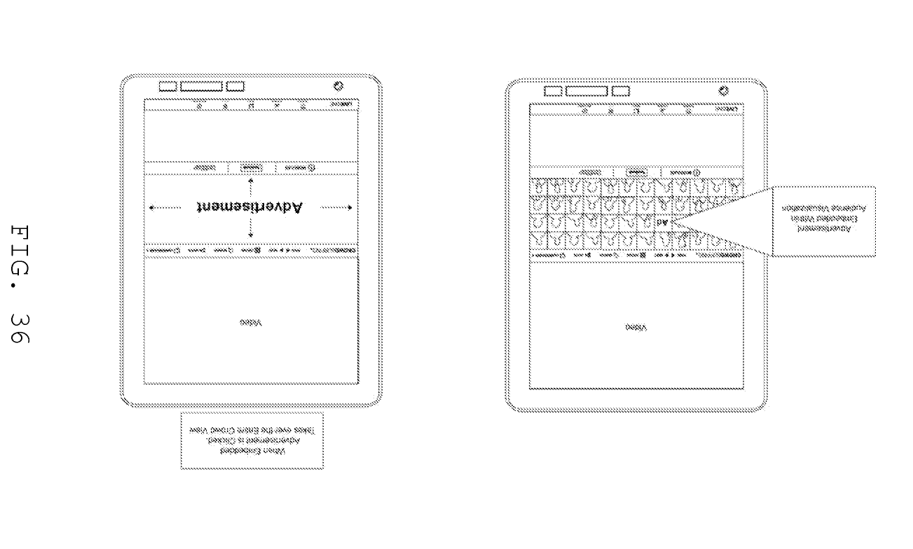

The crowd representation section 110 can also include advertising indicia 120 disposed among the audience icons 118 and adapted for user selection, as shown in FIGS. 32-35.

In one example, the crowd representation section 110 can include a matrix of audience icons 118 arranged in a generally rectangular pattern being 4 or 5 icons high and 12 or 13 icons wide, with each audience icon 118 having a size of approximately 50 pixels by 50 pixels. Generally, the specific dimensions of the crowd representation section 110 correlate to the specific size for banner advertisements in the industry. In contrast to functional and person avatars that can be large and bulky, the audience icons 118 are optimally sized for maximizing quick and efficient user-browsing during the live event. The audience icons 118 also are highly-scalable and facilitate interaction with a high number of individual audience members.

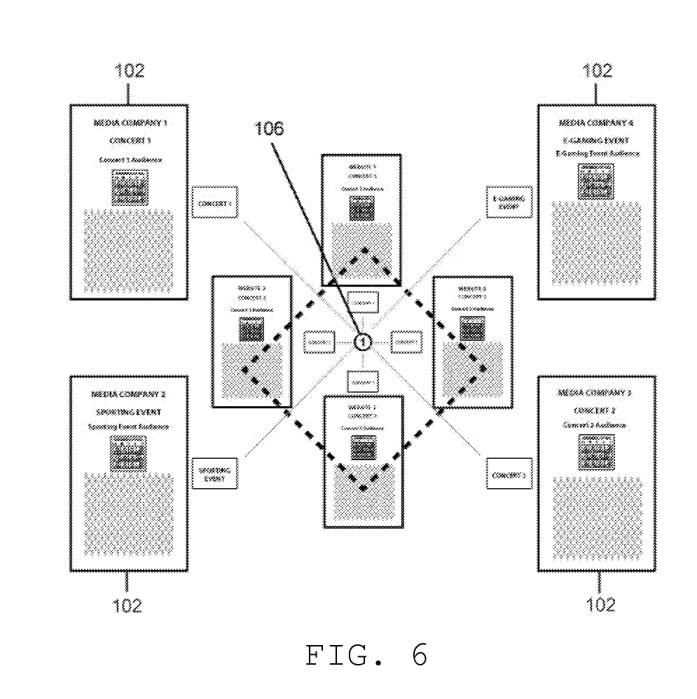

In an alternative embodiment, the social media application 100 can have an arrangement of approximately 12 icons high and 6 icons wide as shown in FIGS. 8, 9B, 9E, and 9G.

### Manipulating Crowd Populations

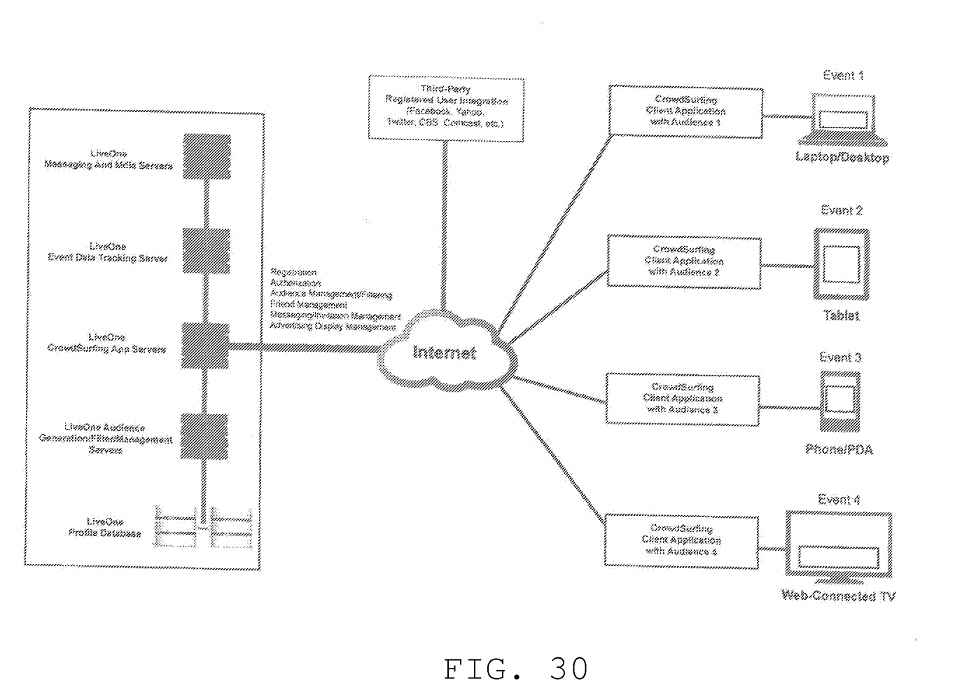

As shown in FIG. 27, crowd representation routine 800 depicts an interaction between the user and the simulated crowd representation section 110. The crowd representation section 110 includes a visual representation of a virtual crowd comprised of audience icons 118 of a plurality of audience members experiencing a real-time event 810. The profile information from at least one audience member, but preferably multiple audience members, is stored 820 at the server. The server confirms the virtual presence of audience members at the live event 830. The server generates a list of the audience members in attendance at the real-time event thereby creating a global audience population specific to the first live event 840. A first limited audience population is created comprising audience icons 118 and associated profile information from the global audience population 850. The first limited audience population can be a random selection of audience members logged into the social media application thereby creating a randomly auto-populated crowd representation section 110. A user may select the “PREV” 122 or “Next” 124 buttons on the upper toolbar 112 at the graphical user interface 108 to change the audience icons displayed in the crowd representation section 110. For example, selecting the “Next” 124 button creates a second limited audience population different from the first limited audience population 860. Again, the second limited audience population can include a random selection of audience members logged into the social media application. The user can create additional limited audience populations as desired. Similar to viewing thousands of individuals while present at a live concert venue, this configuration allows users to quickly scan several audience icons 118 and associated profile information while experiencing the media content.

A user can create limited audience populations comprised of audience icons having associated profile information filtered from the global audience population based on specific profile characteristics. For example, the user can generate limited audience populations using the “Search” button 126 on the upper toolbar 112 to select which audience members appear in the crowd section 110 as shown in FIG. 21. This filters the global audience population according to categories such as geographic location, age, gender, high school, college, other college, town, country, or by profile interests or other search keyword. In another example, the user can filter based on whether they are friends via a third party social media platform such as FACEBOOK.

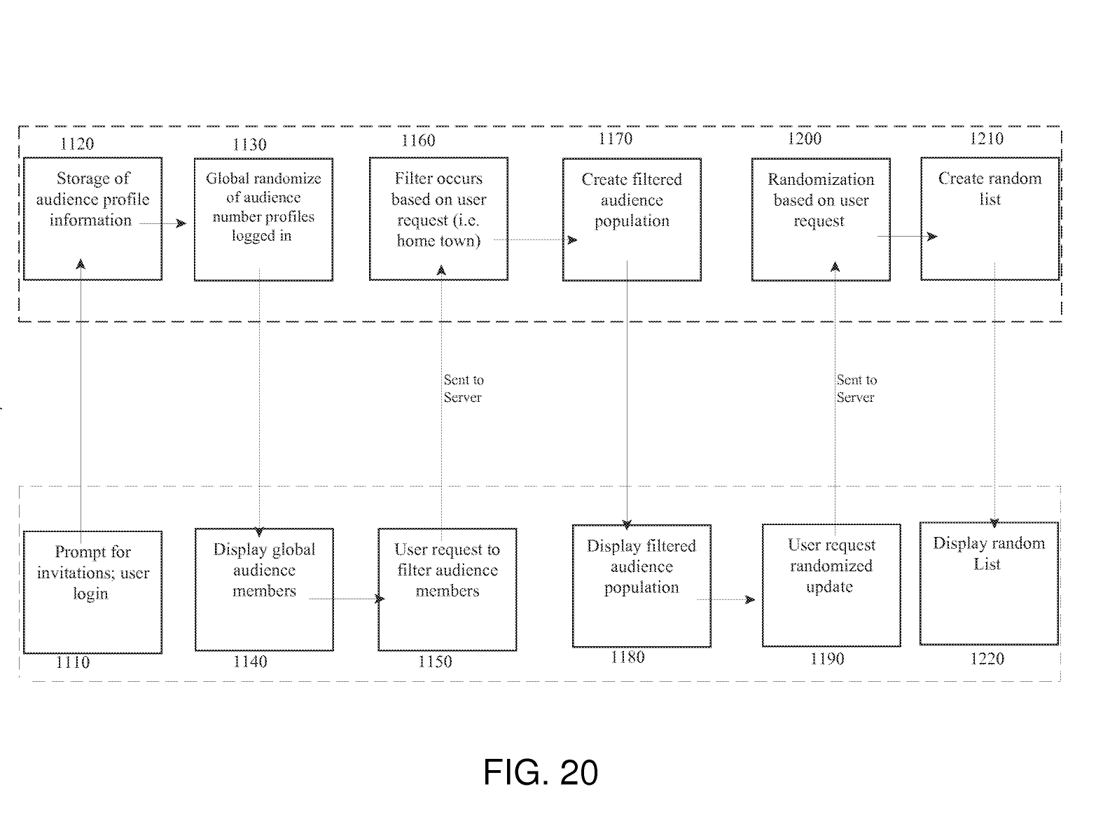

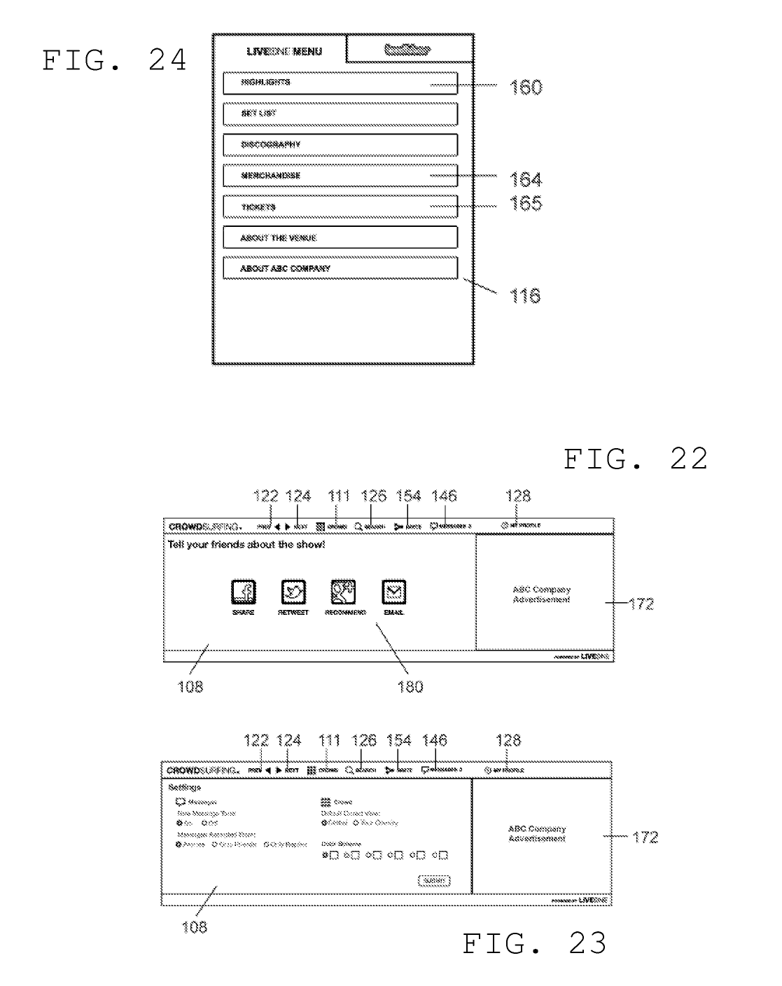

Information can be exchanged between the social media application 100 and the central server 106 freely as desired by the features of the present invention. For example, FIG. 20 illustrates information exchange between the social media application 100 and the central server 106 during the crowd representation routine 800. Users login or are invited 1110 to the social media application 100 at the media content providing platform 102. The audience profile information for those accessing the social media application is stored 1120 at the central server. By default, the server generates a randomized list 1130 of the global audience members logged in at the social media application. The randomized list of the global audience members is sent to the social media application at the media content providing platform and displayed 1140. A user may request to filter the randomized list as desired, such as by audience members from the user's home town 1150. The user may select the SEARCH button 126 at the graphical user interface to choose the filter. The filter request is sent and received 1160 at the server, where the server generates a filtered list of audience members from the user's home town 1170. The filtered list is sent to the social media application at the media content providing website and displayed 1180. The user can continue to browse through the filtered list by selecting the PREV 122 or NEXT 124 buttons. A user may continue to filter, update or randomize the displayed audience members. For example, if the user wants another randomized list of audience members, the user can request a random update 1190 at the social media application, for example, by selecting the PREV 122 or NEXT 124 buttons. The request is sent and received 1200 at the server, where the server will populate a randomized list from the global audience population 1210. The server will send the randomized list to the social media application at the media content providing platform for display 1220.

### User Registration and Profile Information

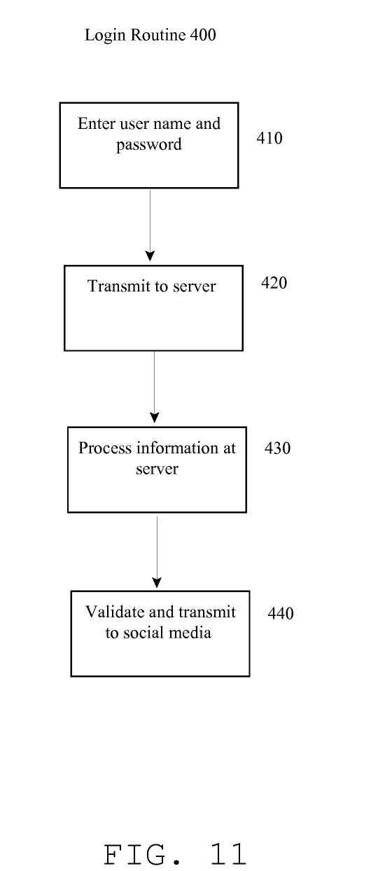

Referring to FIG. 10, a user can register an account using the register account routine 300 for the social media application 100. While at the media content providing platform, the user can enter 310 information including, but not limited to: First Name, Last Name, Email, User Name, Password, Birthdate, Gender, City, Country, and so on. This information is transmitted 320 to the central server for processing, validation and storage. Once validated, the user can login 340 into the social media application. There also can be an option for the user to invite 350 other friends to join the social media application.

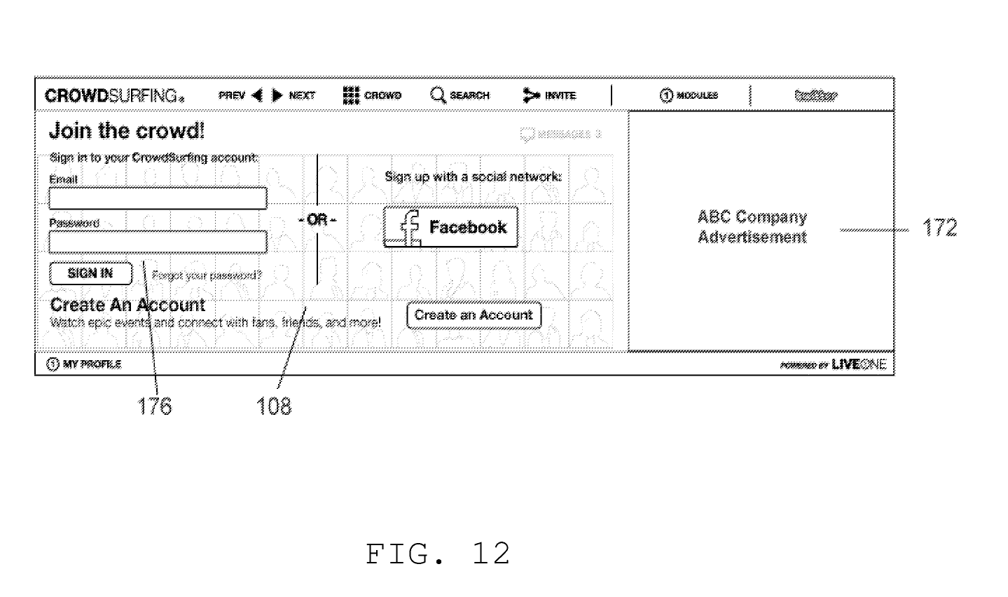

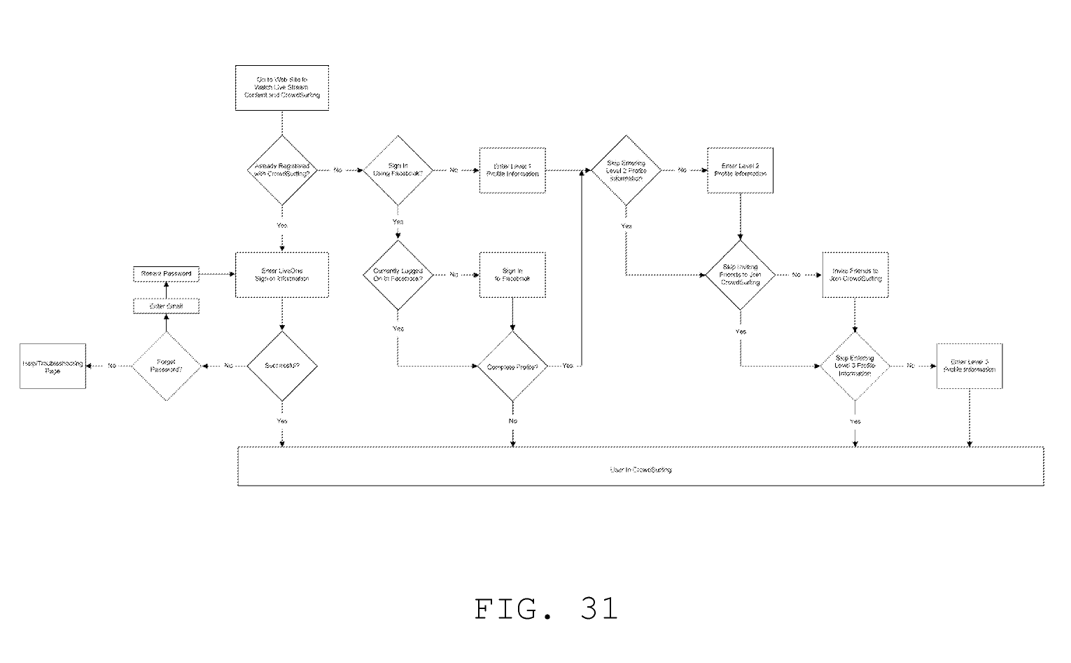

Once the account is registered, the user can access the social media application using a login routine 400 as detailed in FIGS. 11-12 and 31. A user logs in by entering the created user name and password 410 at an input login interface 176 at the social media application. The entered information is transmitted 420 to the server and processed 430. The processed information is validated and transmitted 440 to the social media application 100 thereby logging in the user.

In addition a user may log into the social media application via FACEBOOK or other third party accounts such as YAHOO, TWITTER, or any other application programming interface that enables other partnering web sites to have their registered users directly log in to a system without registering or using their other account username and password.

For example, a user can login using a FACEBOOK account using its FACEBOOK user name and password. The first time the user logs in, the user is asked permission to share and is asked for email for the account associated with the social media application. During subsequent logins, the user is logged in directly to the social media application.

The user can login using a partner account. The first time the user logs in, the user is asked for email to add to the social media application account. The second time, the user is logged in directly to the social media application account.

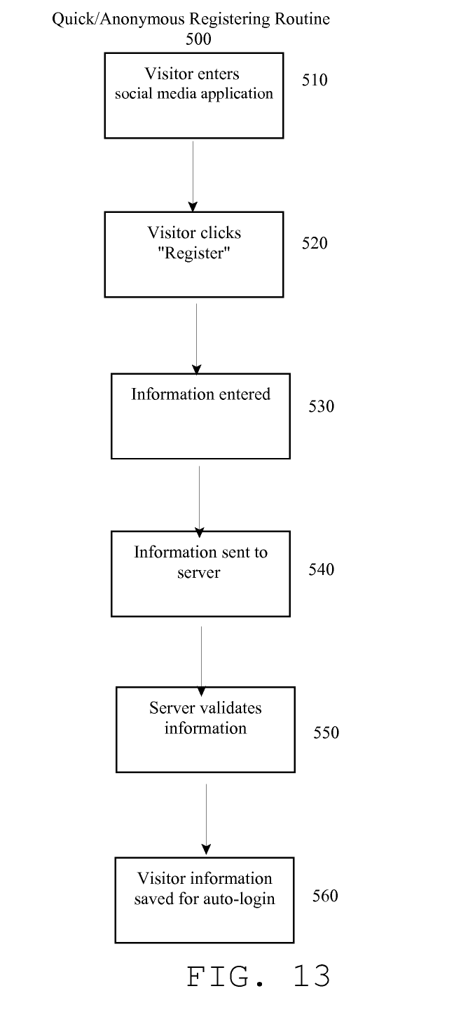

Anonymous users can also access the media content at a third party website without creating a user account. Referring to FIG. 13, a quick registration routine 500 permits an anonymous user to access the social media application. The anonymous visitor enters a web site associated with the social media application such as the LiveOne web site 510. The visitor registers by clicking on the “Register” link 520. The visitor is shown a registration dialog box asking to fill in various information including, for example: Name, Email Address, Password, Confirm Password, and Location 530. Upon submission, the information is sent to the server 540 where a validation will ensure the required fields are filled 550. Once validation is complete, the user will be saved 550 in a database at the server and will be automatically logged into the system.

When logged in, the user can fill out profile information associated with the audience icon by entering various information at a profile input interface including, but not limited to: High School, College, Favorite Artist, Favorite Sports Teams, Favorite Concert Memory, Favorite Sports Memory, and so on. Moreover, the user can upload a profile picture to be displayed as the audience icon 118. Once this information is entered, it is transmitted to the central server 106 where it can be processed and stored. Alternatively, a user can access and update the profile by selecting the “My Profile” button 128 at the graphical user interface 108. Audience Interaction and Messaging

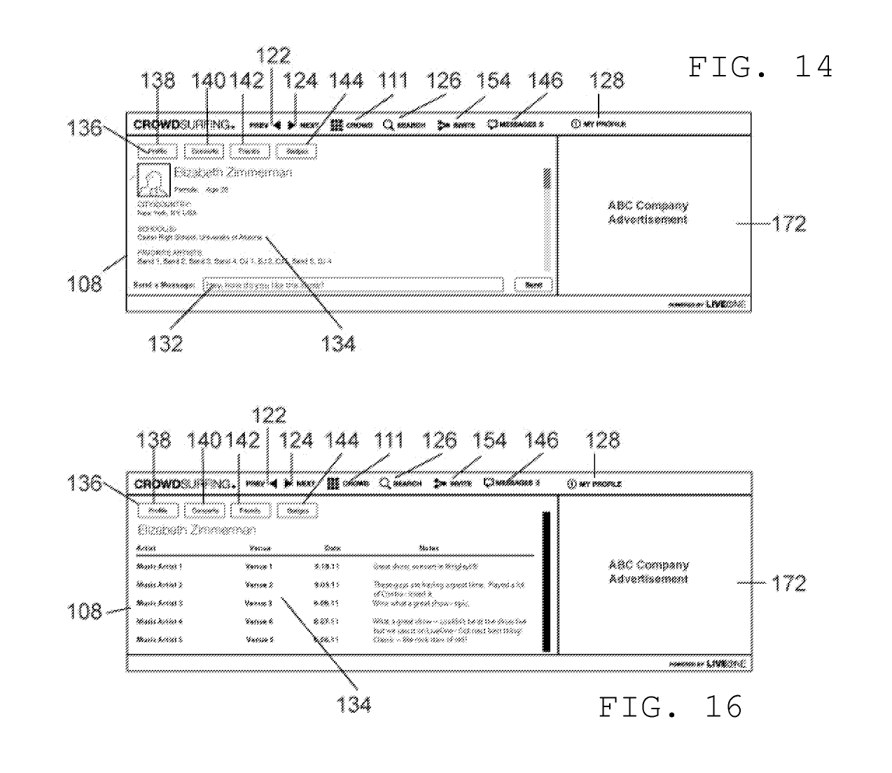

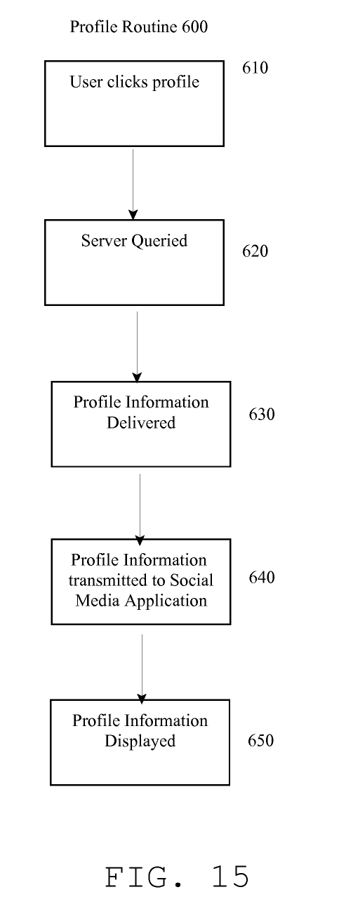

A user logged into the social media application 100 can interact and communicate with other audience members. In one example, a user can select and view profiles of other audience members as shown in FIGS. 14-15. As illustrated in the profile selection routine 600 in FIG. 15, the user clicks 610 on the desired audience icon in the crowd representation section 110. This selection queries 620 the central server with the requested profile information. The requested information is retrieved 630 at the server and delivered 640 to the social media application where it is displayed 650. Alternatively, the profile information can be uploaded from the central server to the social media application at the time the limited audience population is created thereby allowing the display of audience profile information without requesting it from the server. In another example, the user can hover the cursor over an audience icon 118 to obtain a quick view of that audience member's profile information such as the audience member's name and location. This allows the user to quickly scan information concerning multiple audience members.

When viewing audience profile information, the graphical user interface 108 displays an input interface 132 showing selected audience profile information and a dialogue board 130 for displaying user-messaging as illustrated in FIG. 14. This permits the user to view selected profile information 134 in the social media application 100 and does not require the user to access an external website or other external location. In one example, the audience profile information displayed can correlate to the type of media content being experienced. For example, if the user is experiencing a music concert, the profile can be automatically populated to display profile information associated with music or the particular performing artist.

The input interface 132 showing profile information can be arranged with customizable tabs 136 for displaying organized server stored information concerning the selected audience member. This permits the organized access of various information concerning the selected individual. As a default, the customizable tabs 136 include, for example, a profile tab 138, concerts tab 140, friends tab 142, and badges tabs 144. Additional tabs, however, can be added and removed as desired. An individual can also provide security access regarding which individuals can have access to this information.

As shown in FIG. 16, the concerts tab 140 includes information concerning various concerts. In this example, the information listed is the artist, the venue, the date of the concert, and notes concerning the concert, for example. This allows those viewing the concerts tab 140 to see what concerts the selected individual attended and the various notes associated therewith.

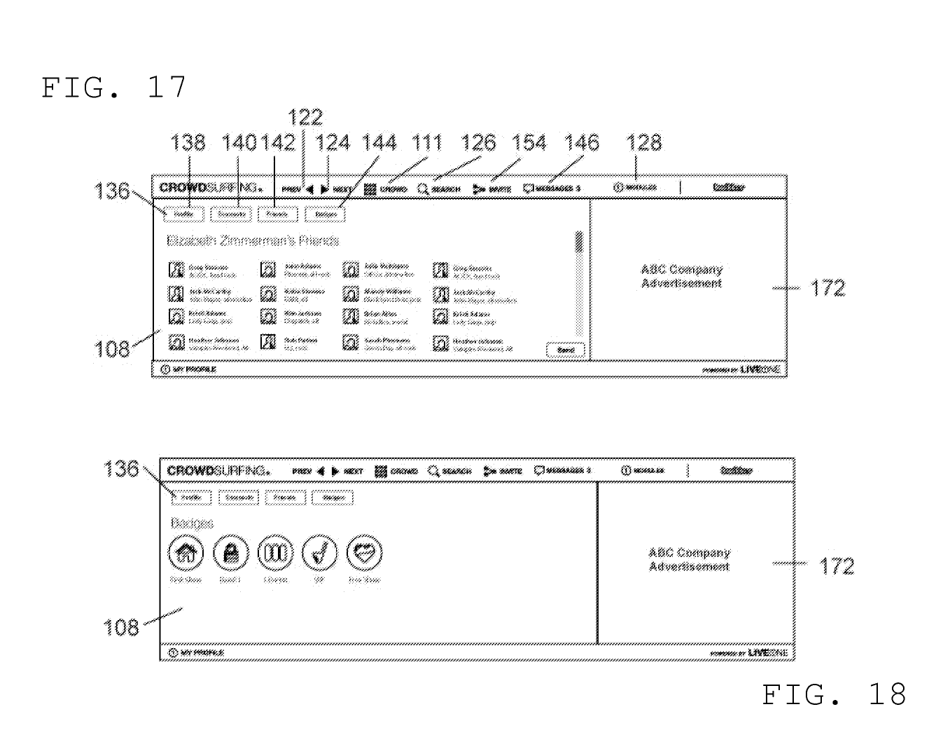

The friends tab 142, generally shown in FIG. 17, displays the various “friends” of the selected user and can also indicate the “friends” the user has in common with the selected audience member.

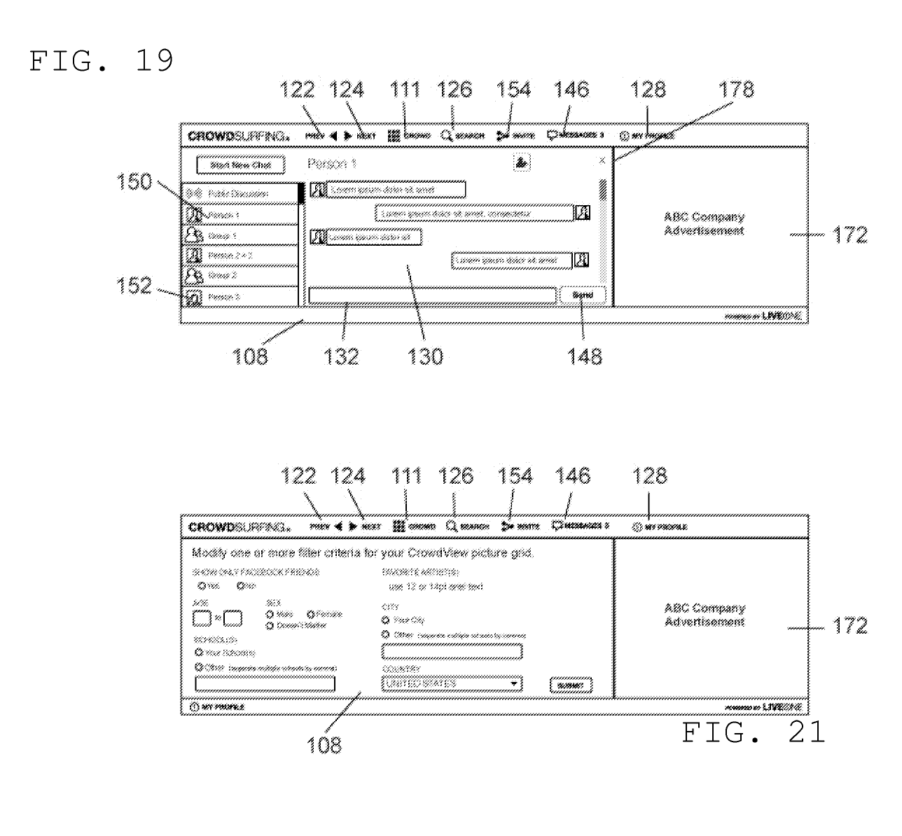

The badges tab 144 is shown in FIG. 18 and displays various awards and achievements associated with an audience member's activity within the social media application. An audience member can acquire badges by viewing certain types of media content, spending a predetermined amount of time experiencing media content, or winning rewards for various games presented during the live event as discussed below.

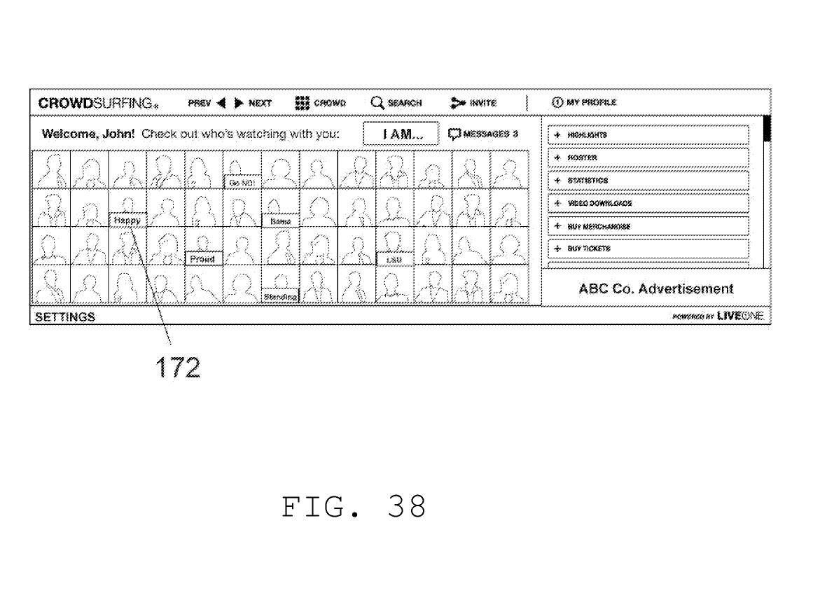

As shown in FIG. 38, a user may also add status indicia 187 that will appear as an overlay associated with the audience icon 118 for that particular user. This status indicia 187 can be changed by the user throughout the course of an event to indicate, for example, the user's emotions or response to a particular event. Such status indicia 187 can be selected from a drop-down menu 188 providing several choices for the user to select, such as “cheering,” “excited,” “amazed,” “sad,” “stunned,” “standing,” or “proud” and so forth. Status indicia 187 can be added to the audience icon 118 by other mechanisms as well, such as typing a user-selected status into a text box for posting to an audience icon. Selection and display of these status indicia allows a user to portray emotion to the rest of the virtual audience in a manner that enhances the group watching experience. A user can also observe the emotions of the other audience members to ascertain the crowd's emotions and responses to various occurrences happening during the event.

For example, a user could choose “cheering” as a status indicia 187 if a certain sports team scores during a game, or “stunned” if that sports team unexpectedly loses the game. Likewise, a user could chose “standing” to support a person or persons who is describing a particularly difficult or challenging personal situation.

Status indicia 187 are not limited to emotions (such as “happy”) or actions (such as “clapping”), and can also include designations of affiliations, such as sports team affiliations or political party affiliations. For example, a user watching a political debate could choose “Republican” as her status indicia 187 to designate her affiliation or support of a certain candidate. A user can sort the crowd based upon the status indicia 187. For example, the user can search the crowd for certain status indicia (such as “happy,” or “republican”) and the crowd can be filtered to reflect audience members having the particular status indicia 187.

The social media application 100 permits communication between the user and audience members through messaging. A user can send messages to selected audience members as shown in FIG. 19. A user views audience member messaging by selecting message icon 146 at the graphical user interface. In response, the graphical user interface 108 provides the input interface 132 having a dialogue board 130 for allowing a user to post a message to a selected audience member. Alternatively, while viewing the selected audience member's profile, a user can send a message by typing the message in the input interface 132 and click send message button 148 to transmit the message to the desired individual. Accordingly, the graphical user interface can include a message interface 178 where the user can view sent and received messages.

Referring to FIG. 19, the user can carry on multiple message conversations with different individuals. In this example, the user can select from a specific audience member tab 150 to generate a display of an input message interface associated with that particular audience member. Similarly, the user can select another audience member tab 152 to generate a display of another input message interface associated with that conversation.

The user can also select the comment feed from particular audience members to follow during the course of an event or for another time period. For example, a user may select to follow the comment feed from an audience member who is located in the crowd at the live event. The user can determine which audience members are attending an event based upon location indicators 185 affiliated with audience icons 118. By further example, a user may select to follow the comment feed of unique audience members, such as a celebrity audience member who has an affiliation with the particular event taking place. The user can also select to follow the comment feed of particular audience member whenever that audience member comments, regardless of the time or the event.

The social media application 100 also permits communication between the user and audience members using a question-and-answer interface. This question-and-answer interface can also be used to permit communication between the audience members and the media content provider. The user can post a question or comment to other audience members via a question and answer interface. The question can be posted to the global audience population or a limited audience population using the crowd manipulation functionality described herein. An individual user in the relevant audience population can respond to the question by posting an answer on the question and answer interface. This answer can be displayed to all users in the relevant audience population, to a subset of the relevant audience population, or to only the original individual questioner.

The media content provider can also post a question or comment to the audience members via the question and answer interface. In this manner, the media content provider can obtain information in real-time from the audience population about the content being provided. For media content that is a live event such as live television programming or a political debate, the media content provider can ask questions of the audience at key intervals to obtain audience opinion about any aspect of the live event. For live broadcasts of previously-recorded content, the media content provider can post questions or comments to garner audience interest in events that have been or are soon to be broadcast to the audience.

### Audience Invitations

In another embodiment, a user can invite multiple selected individuals to a particular message group to provide a group chat experience. In this example, the user can select a desired chat group or be invited into a particular chat group. The dialogue board 132 can therefore be used to post messaging to the entire group of audience members.

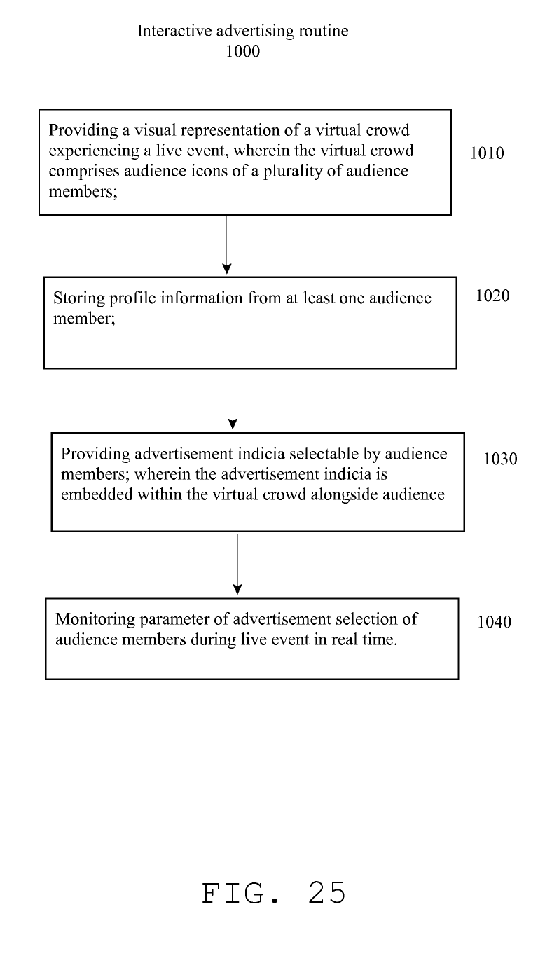

The social media application 100 also allows users to invite others to join and experience media content during a live event as shown in FIG. 22. For example, the user can select the “invite” feature 154 at the graphical user interface 108 to display an invite interface 180 for allowing the user to tell friends about the media content. In one example, the user has the option of using, for example, the FACEBOOK application, Tweeting or Retweeting via the TWITTER application, Recommending via GOOGLE+ application or e-mail to share the experience.

Users can invite individuals to experience media content after commencement of a live event. This can uniquely drive audience traffic to media content in response to an special occurrence at live event, such as overtime during a sporting event. This unique crowd-delivery is one of the benefits of the present invention. Referring to FIG. 28, the user can send real-time invitations to individuals to attend a live event according to the invitation routine 900. In particular, a user can invite a user to attend a live event once an event has started. Once a logged in user is confirmed 910, the processor can prompt the user to invite other individuals to attend the live event even after the event's commencement 920. The prompting can occur at randomized time intervals during the live event, in response to a triggering event associated with the live event, or in response to an advertisement. The processor can track the time when the at least one user sends the invitation to the invitee 930. The process can track the identity of the invitee based upon identifying-indicia provided by the user 940. The identifying-indicia can include an e-mail address of the invitee or a code provided to the at least one audience member to convey to the invitee. Once the invitee joins, the processor obtains confirmation of attendance at the live event within a count-down period 950. The count-down period can be a period of time communicated to the user to convey to the invitee. Notification is provided to the user that the invitee is in attendance at the real-time event 960. The notification can be in the form of granting a reward to the user and can be provided to the user by an advertising sponsor of the live event. In addition, a reward can be given to the invitee if login or joining the event is completed within the count-down period. A reward can also be given if a user sends out a certain number of invitations, regardless of whether these invitations result in the invitee joining the event. Numerous other rewards based upon user participation in sending invitations can be implemented.

The social media application 100 can also automatically complete a partially existing group by sending invitations to individuals based upon a triggering event. For example, the application 100 can automatically send an invitation to members of a group when any member or members of a group logs into an event. A group can be defined by pre-existing criteria in user profiles. This pre-existing criteria could establish that several registered users are part of group. The group can be based upon any criteria, such as being members of the same sports league, social club, neighborhood association, or other group. The pre-existing criteria is generally independent of any particular event or media content to which the group is being invited. The automatic invitation feature allows a pre-existing group to gather and become partially or fully complete on the social media application 100 without specific prompting or invitation from a specific member of the group.

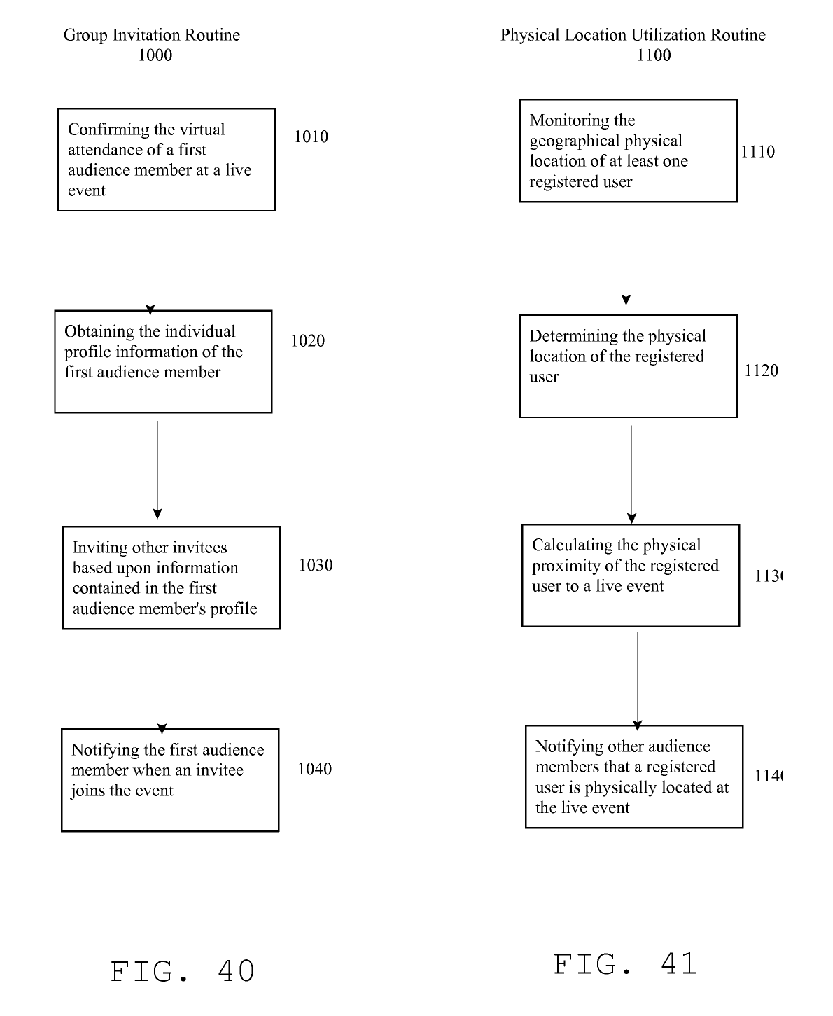

Referring to FIG. 40, the social media application can automatically invite individuals related to an audience member according to the group invitation routine 1000. In particular, the application confirms the attendance of a first audience member at a live event 1010, and the application also obtains the individual profile information to the first audience member 1020. Based upon information contained in the first audience member's profile, the application sends invitations to other invitees 1030. These other individuals receiving invitations are usually registered users with their own individual profile information stored on the application. The application then notifies the first audience member in real-time when the invitee joins the event 1040. The notification to the first audience member can be in multiple formats, including sending a private message to the first audience member, or automatically adding the invitee into a group messaging board.

If the invited individual logs on to the event, other members of the group are notified of the invited member's presence. In a preferred embodiment, the invited member is automatically placed into a messaging interface with the other group members present at the event. In this way, the partial group can be completed with other members and the members of the group can communicate and interact with each other. This automatic invitation feature of the social media application 100 also helps drive audience traffic to media content.

### Interactive Advertising

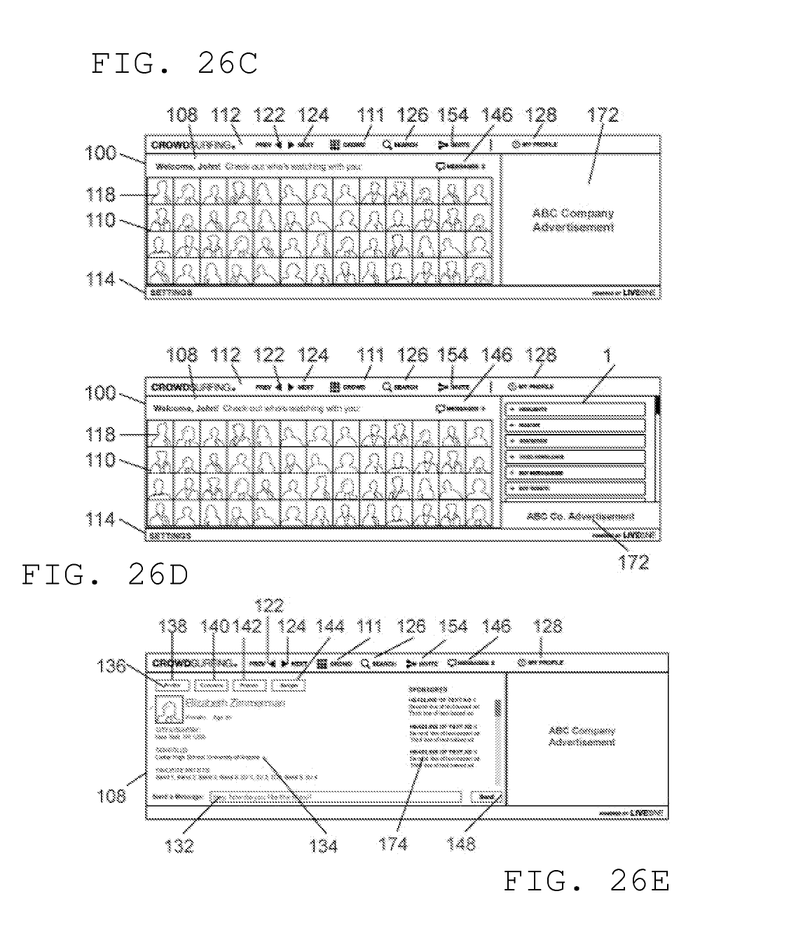

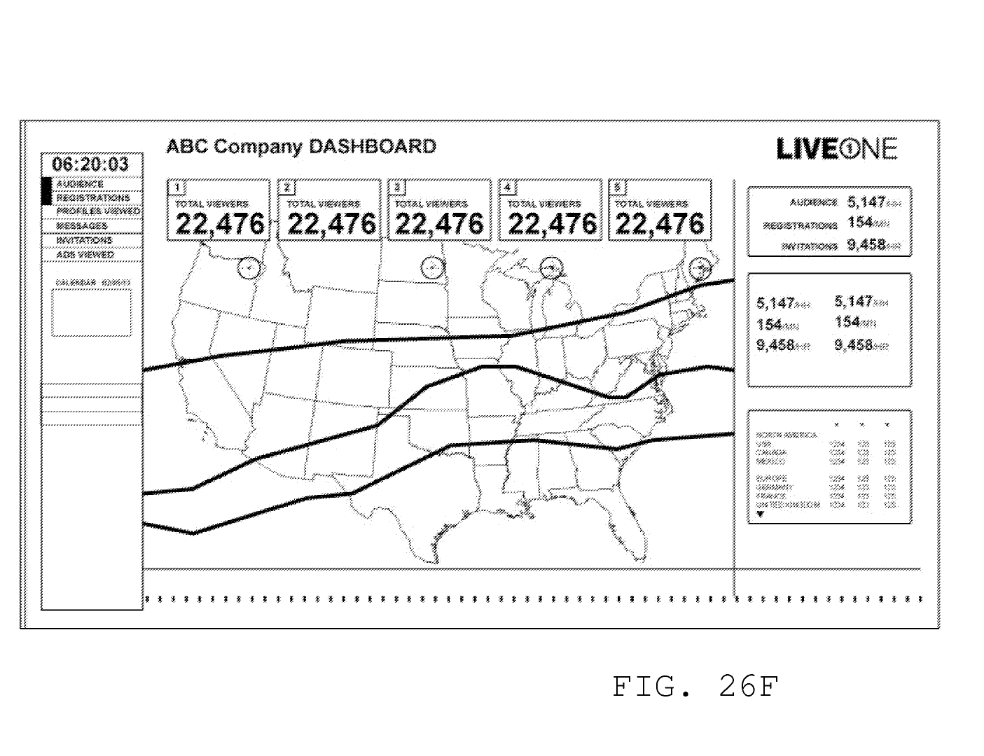

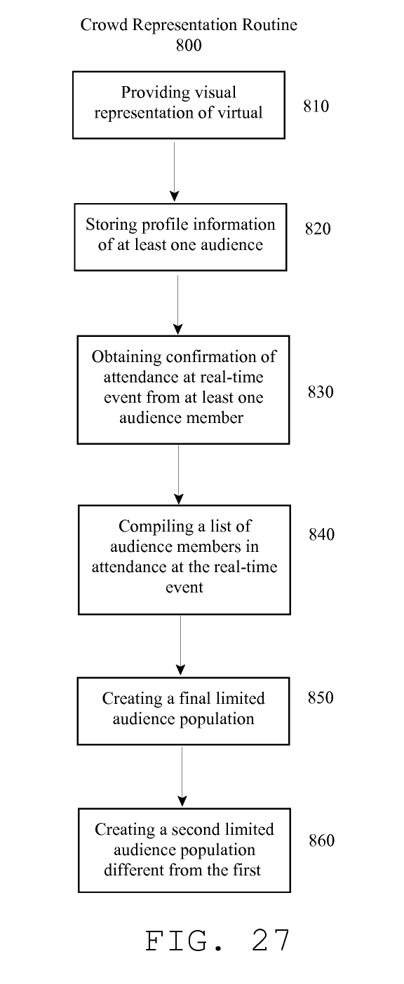

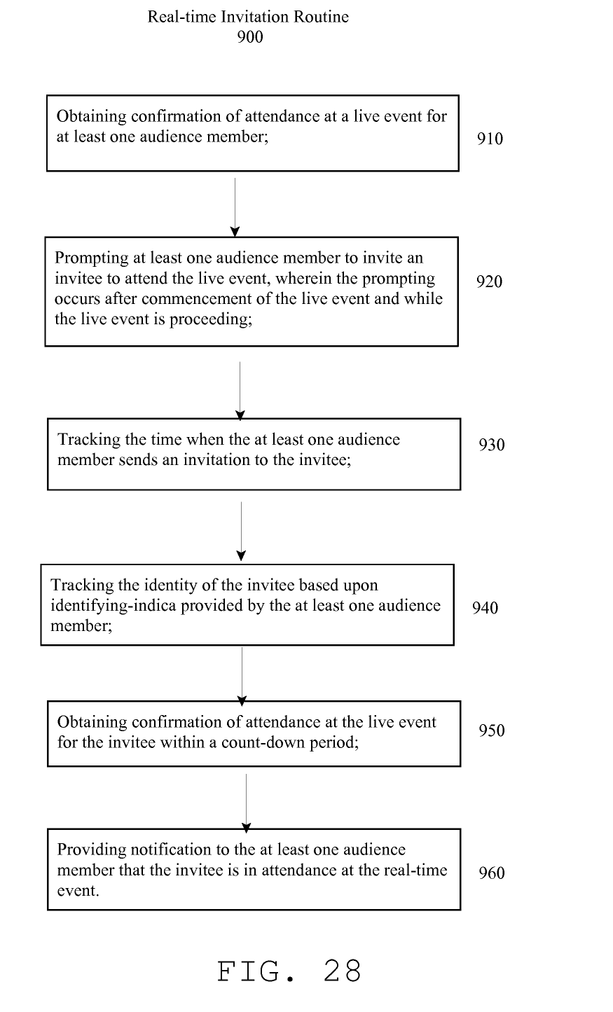

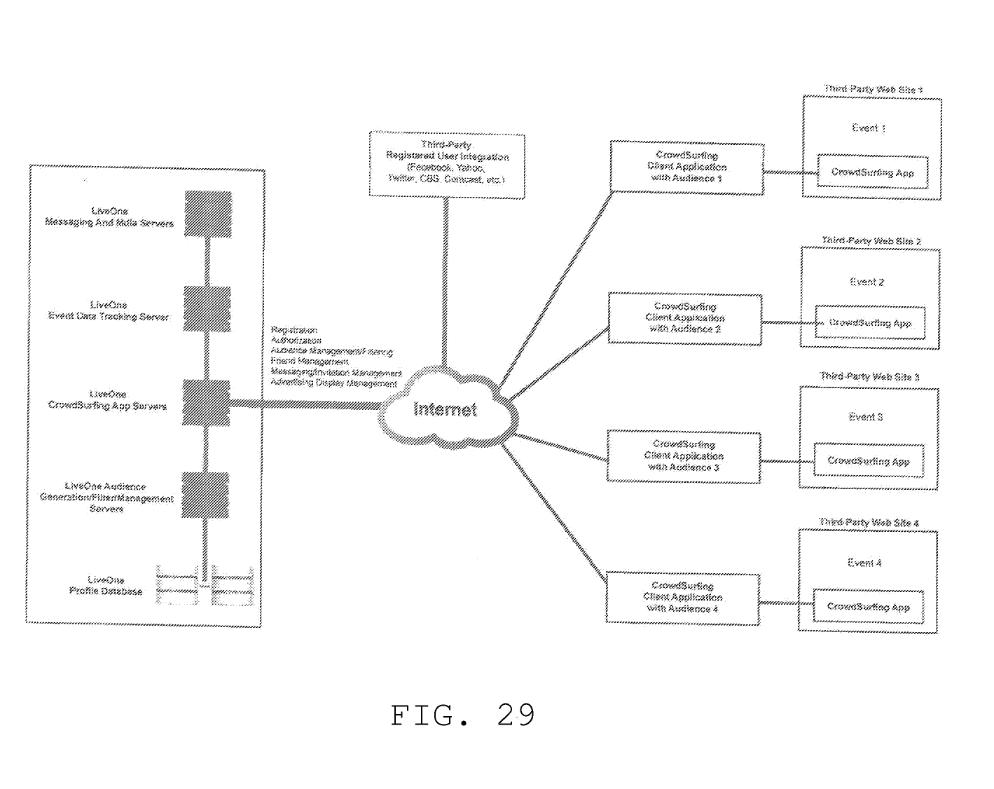

The social media application 100 provides for incorporating a variety of advertising techniques for presenting advertisements as shown in FIGS. 26A-26F. Advertising indicia can be displayed at various locations at the social media application 100 and can have a rich media format and presented in a variety of interactive formats including text, graphics, animation, video, and audio. Different applications can be triggered when the user interacts with the advertising indicia. In one example, the advertising indicia can be blown up when the user hovers the cursor above the advertising indicia revealing an enlarged version of an advertisement. The enlarged version of the advertisement can include a two line sponsor logo for both increasing marketing visibility and for distinguishing the sponsor relative to other audience member icons. In another example, clicking on the advertising indicia or advertisement generates an enlarged version of the advertisement. Still, in another example, clicking on the advertisement can cause the user to be directed to an external website containing information about the advertised product or promotion.

Advertisements can be displayed based upon a number of criteria including individual profile information, sponsorship of a particular live event or in response to a specific occurrence in a live event such as a touchdown or three-point shot during a sporting event.

Referring to FIG. 25, an interactive advertising routine 1000 during a live event includes the existence of a visual representation of a virtual crowd, comprising audience icons of a plurality of audience members, experiencing a live event 1010 and storing profile information 1020 from the audience members. Advertising indicia, stored at the central server and displayed at the graphical user interface alongside audience icons, is selectable 1030 by audience members. The server is adapted for monitoring a parameter associated with the advertisement selection of audience members during live event in real time 1040. The parameter being monitored can include start-time of the event, duration of access, frequency of access, related advertisements accessed or any other combination thereof. The parameter being monitored can also be cross-referenced to the events occurring during the live event or profile information associated with an audience member. Accordingly, information concerning these monitored parameters can be tracked and stored at the central server 106.

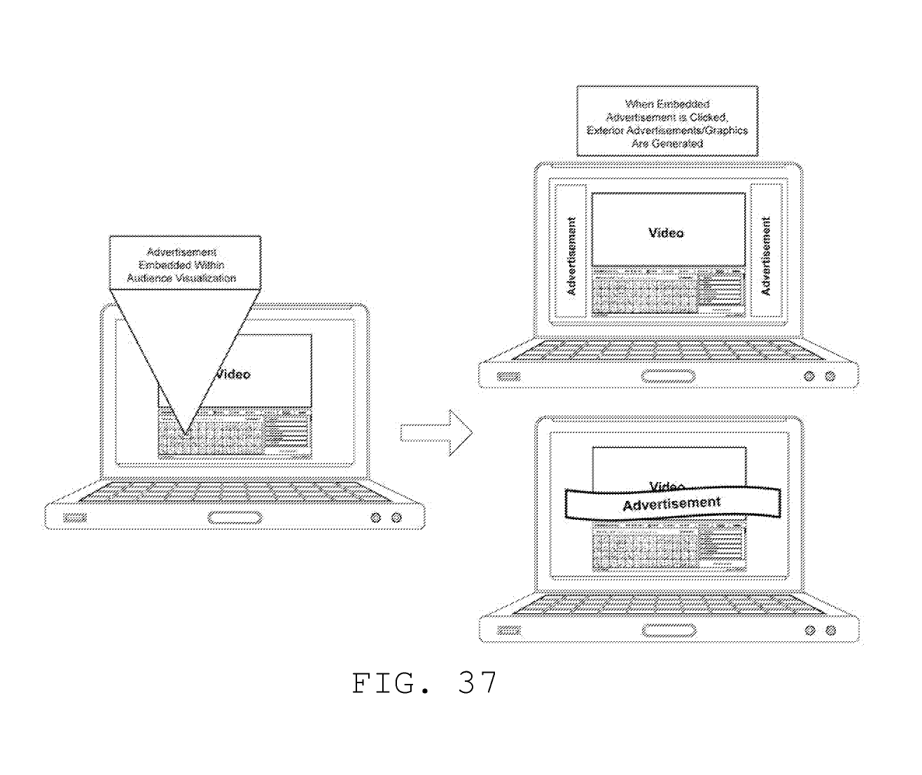

Various types of advertising indicia and advertisements can be used. For example, FIG. 26A shows an embedded advertising indicia 166 at the graphical user interface 108 disposed adjacent a plurality of audience icons 118 within the crowd representation section 110. This embedding or “crowd seeding” is particularly advantageous because it captures the attention of a user who is viewing audience icons 118 that are directly proximate the advertising indicia 166. This is particularly advantageous considering the advertising indicia 166 has substantially the same 50 pixel by 50 pixel square shape and size of the audience icon 118. When selected by a user, the advertising indicia 166 can trigger an interactive activity such as generation of advertisements or graphics within the social media application 100 or at the content providing platform. As shown in FIG. 37, selection of the advertising indicia 166 causes the generation of advertisements or other graphics outside the social media application 100 at the content providing platform 102.

In other examples, selection of the advertising indicia 166 generates advertisements or graphics within the social media application 100. For example, selecting the advertising indicia 166 can transform to display a full panel 970 pixels wide×250 pixels wide advertisement or non-advertising graphic 168 to conceal one or more audience icons. The full panel advertisement 168 can include various media including visually rich images, video presentation, or include additional links to external web sites or other locations. In other examples, selecting the advertising indicia 166 can cause an advertisement or graphic to fill the entire web page, to appear at a portion of the side, top, or bottom of the web page, or to move across the visible content of the web page. This process can be localized within the social media application 100 and therefore there may be no need to transmit any information to the server 106 to show the full panel advertisement.

Referring to FIG. 26B, 32-33, the advertisement may be an embedded sponsor profile 170 in the crowd representation section 110. This type of advertisement 170 can be a visually rich profile containing images, video presentation, and permits page scrolling to access additional advertisement. Accordingly, when clicked on by the user, the graphical user interface 108 will display an enlarged visually rich advertisement 171 allowing the user to scroll up or down to see the entire advertisement. Clicking the sponsored profile 170 can also trigger generation of a new advertisement in the banner display, as well.

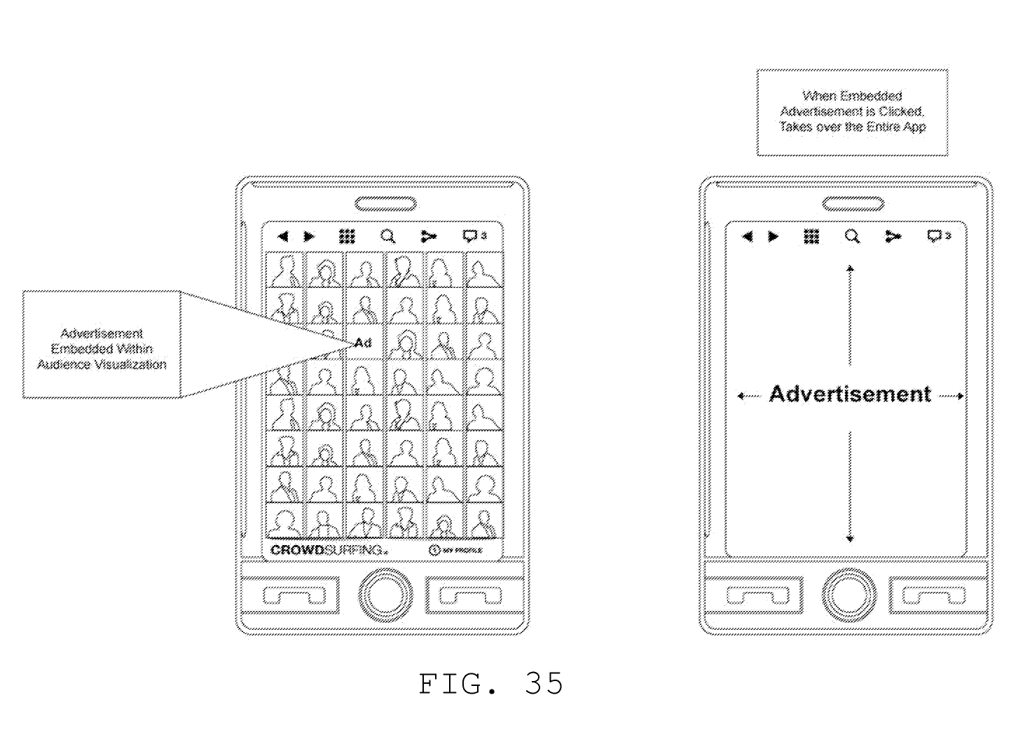

As shown in FIGS. 34-36, embedded advertising indicia 166 and embedded sponsor profiles 170 can be implemented for advertising at the social media application 100 for display on various computing devices including mobile devices, tablet computing devices and televisions.

A banner advertisement 172, as shown in FIGS. 26C-26D, shows an advertisement proximate the audience icons 118. The banner advertisement 172 can have a 300 pixels wide×250 pixels high size but can be collapsed as shown in FIG. 26D to reveal the customizable menu 116. This size advertisement generally conforms with the Internet Advertising Bureau Standard. Accordingly, many advertisements are designed according to these dimensions thereby facilitating advertisement integration within the present invention. In one example, the banner advertisement 172 can be removed or hidden to present additional audience icons 118. In this example, the crowd representation section 110 could be expanded to 19 icons wide×5 icons high.

A text advertisement 174 can also be shown as illustrated in FIG. 26E within the a selected profile section of an audience member. In this example, the text advertisement 174 can be displayed next to the profile being viewed.

Advertisements can also include interactive game features within the social media application 100. The games require the user to interact with the advertising indicia in the hopes of completing a task or achieving a goal, oftentimes, during a particular time frame. For example, one type of game advertisement involves a treasure hunt format where advertising indicia, such as a bottle cap associated with the advertised product, is hidden within the crowd representation section 110. The user plays the game by visually searching the crowd representation section 110 to find the hidden advertising indicia and clicking on the advertising indicia. In another embodiment, the selecting of advertising indicia can be tracked by time of selection, and the audience member selecting the highest number of items within a given time could be award a prize. Exclusive or limited-time offers can be awarded if the user completes the game within a certain time period. These games can be driven by the occurrence of events during the live content, such as a break or timeout during a sporting event.

User data and activity occurring at the social media application can be tracked and delivered to the central server 106 for processing and storage. This data and activity can be used to generate various kinds of statistics and reports as shown in FIG. 26F. For example, user tracked data and activity can include: events for which the user signed up, events the user logged in, source origin of the user log in (e.g. direct, partner site, advertisement, media campaign, etc), the date and time of the log in for event, the location from which they log in for event, time they log off from an event, total time spent on event, and so on. Similarly, activity concerning the advertisements selected by the user can also be tracked. As detailed in FIG. 26F, audience data concerning the audience registration at events, the total number of clicks on a particular advertisement, the location of the audience clicks as well as the specific user clicks can be recorded and stored. Accordingly reports can be generated detailing and organizing these valuable statistics according to, for example, event, day, month, or year. These reports can be exported to advertising partners for review and analysis.

### Audience Member Location Data Utilization

In another embodiment, the social media application 100 can utilize location data of individual audience members to enhance audience experience for the global audience population. In particular, individual audience members who are attending a live event that is also being broadcast in real-time can interact with the social media application 100 via a mobile device to provide on-location information to audience members who are watching the event remotely.

The social media application 100 approximates many aspects of attending an event in person, and communicating with an individual who is located on-site at the live event adds another element to audience members that further blurs the line between live and remote viewing. Communication with an on-site individual audience member allows the remote audience to obtain minute details regarding the live event in real time. For example, rather than rely upon a sideline announcer at a sporting-event to provide intermittent updates regarding the live event, remote audience members can communicate directly with on-site audience members to obtain information about the event such as crowd size, event atmosphere, noise level, or general off-camera activity that can only be seen by the on-site individual.

Communication between a remote audience member and an on-site individual audience member also enhances the viewing experience for the on-site individual. For example, the on-site individual can obtain information about slow-motion replays of events or commentary being provided by the media content provider that are not available to the on-site individual.

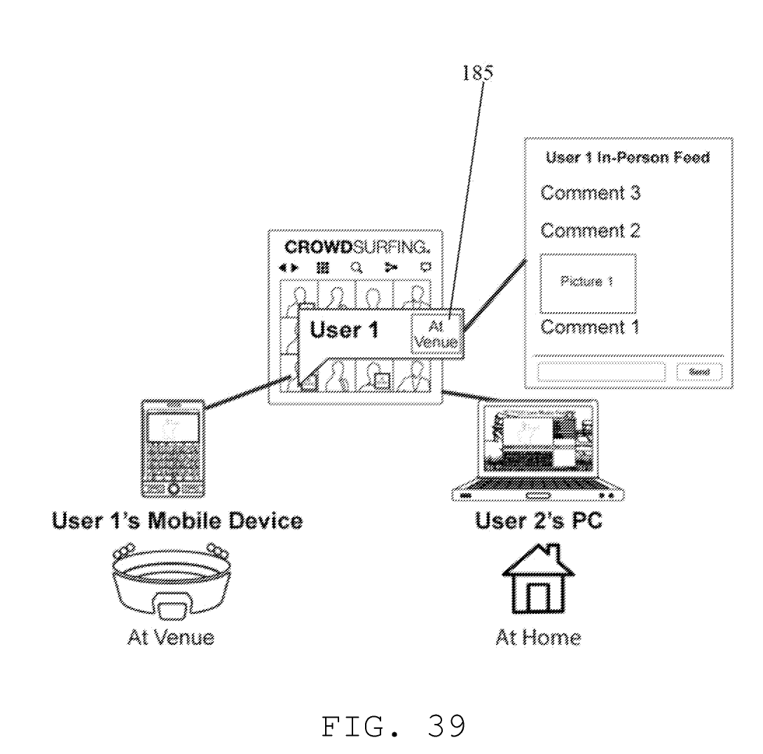

As detailed in FIG. 39, the audience icons 118 in the crowd representation section 110 of the graphical user interface 108 can include location indicators 185. Location indicators 185 can appear on an individual audience icon 118 when that individual audience member is located at a particular live event, or within a certain distance of the live event. For example, an icon showing a star, asterisk, raindrop or other shape or phrase can appear on the audience icon 118 of audience members who are located within an arena or viewing area of a particular event. An audience member can view the crowd representation section 110 to locate audience icons 118 having this location indicator 185 and can seek out these specific audience members to send messages. A remote audience member can also view general comments, videos, pictures, and one-to-one discussions or group discussions from various on-site audience members in order to obtain real-time information about the live atmosphere from the on-site audience members' perspective. These features enhance the viewing experience for both remote and on-site audience members, and further blur the line between viewing media content remotely or attending an event in person. Individuals physically separated from one another can experience an event together as if the individuals were sitting together at the event or at the remote location.

The location data of individual audience members can be integrated into the social media application 100 in a variety of manners. For example, individual users can manually check-in or otherwise indicate when they are physically present at a particular live-event. This manual check-in can occur, for example, by the user updating his user profile or by checking a box or other prompt that appears on the graphical user interface 108 at some point during the live event.

Location data can also be obtained automatically by monitoring the GPS coordinates of an individual user's mobile device, and setting triggers that would automatically result in the user's audience icon 118 being updated with a location indicator 185 when a mobile device becomes located within certain geographic parameters. A computer program or other computer readable medium designed to automatically integrate location data into the audience icons can be stored on an application server associated with the present invention shown, for example, in FIG. 29.

Referring to FIG. 41, the social media application 100 can utilize audience location data according to the physical location utilization routine 1100. The application monitors the geographical physical location of at least one registered user 1110. The at least one registered user may be logged in to a particular event at the time the application monitors the location, or the application can monitor registered users without reference to whether they are logged in to an event. The application determines the physical location of the registered user 1120, by for example, analyzing GPS coordinates associated with that user or by observing information provided by the user regarding location. Based upon the user's physical location, the application calculates the physical proximity of the registered user to a live event that is occurring at that particular time 1130. If the user is located at or near an event, the application provides a notification to other audience members that the registered user is physically located at the live event 1140. This notification can be in many forms, including, for example, by displaying a location indicator on the appropriate audience icon, creating a limited audience population comprised of audience members physically located at a particular event, or providing searchable indicia to allow an audience population to filter by this feature.

As described above, the social media application 100 of the present invention creates a valuable scenario in which audience members are driven to media content providing platforms 102. Audience members are driven to the content provider platform in part because of the desirability of experiencing media (especially live media) with other audience members. The present invention provides several features that further increase this group-interaction dynamic and further increase audience participation.

For example, an audience member's ability to scan or “surf” the crowd using the present invention's highly scalable and easily maneuvered simulated crowd greatly enhances the audience experience. An audience member's ability to invite friends in real time based upon a specific occurrence in a live event allows the audience member to personally spread the excitement of a cultural event to his social network. The social media application's ability to automatically invite individuals related to another audience member also enhances the audience experience. The social media application of the present invention provides a platform to harness the energy created by an exciting cultural event by providing the platform from which additional audience members can stream to the event. In most live event situations, audience attendance does not increase once an event begins.

The social media application of the present invention can be integrated with pre-existing social networks such as FACEBOOK and TWITTER in order to leverage these existing networks and increase audience participation at a content provider's platform.

Of course, one of the key benefits of the increased audience size and audience engagement provided by the present invention relates to advertising. Increased audience attendance translates into increased advertising fees that a content-provider can obtain. The ability to target specific audience demographics in real-time, and the ability to integrate advertising into interactive games and contests related to the live media content further increases the value of the present invention to audience members, content-providers, and advertisers.

The foregoing description and the accompanying drawings are illustrative of the present invention. Still other variations and arrangements of parts are possible without departing from the spirit and scope of this invention.

1.-42. (canceled)

43. A system for providing a computer simulation of a live event, the system comprising:
one or more computing devices;
one or more storage devices having stored thereon instructions that, upon execution by the one or more computing devices, to cause the system at least to:
receive a request from a content provider to provide a client device with access to the computer simulation;
transmit, in response to the request, an application that performs at least a portion of the computer simulation on the client device, the application comprising instructions that, when executed, forms visual representations of a simulated crowd attending the live event;
maintain a plurality of profiles representative of virtual attendees connected by a network to the computer simulation of the live event;
select a first subset of the plurality of profiles based at least in part on random selection from the plurality of profiles;
cause the application to display, on the client device, a first visual representation of the simulated crowd, wherein the first visual representation is generated by the application and comprises a first plurality of audience icons corresponding to the first subset and a first graphical indicia provided by the content provider, the first graphical indicia based at least in part on profiles in the first subset; and
cause the application to display, in response to a selection by a user of the client device, a second visual representation of the simulated crowd, wherein the second visual representation is generated by the application and comprises a second plurality of audience icons corresponding to a second subset of the plurality of profiles, the second subset based at least in part on profiles in the second subset matching a profile characteristic, the second visual representation further comprising a second graphical indicia provided by the content provider, the second graphical indicia based at least in part on profiles of the second subset.

44. The system of claim 43, further comprising one or more storage devices having stored thereon instructions that, upon execution by the one or more computing devices, cause the system at least to:
receive a request from a second content provider to access the crowd simulation for the live event; and
transmit the application on behalf of the second content provider.

45. The system of claim 43, further comprising one or more storage devices having stored thereon instructions that, upon execution by the one or more computing devices, cause the system at least to:
confirm attendance at the live event of an audience member corresponding to a profile in the plurality of profiles.

46. The system of claim 43, wherein the first subset is based at least in part on randomizing profile information from the plurality of profiles.

47. The system of claim 43, wherein the second subset is based at least in part on a random selection of profiles in the plurality of profiles that match the profile characteristic.

48. The system of claim 43, wherein the second subset is based at least in part on a geographic region.

49. The system of claim 43, further comprising one or more storage devices having stored thereon instructions that, upon execution by the one or more computing devices, cause the system at least to:
prompt the user to send an invitation to an invitee to attend the live event, wherein the prompting occurs after commencement of the live event and while the live event is proceeding;
obtain confirmation of attendance at the live event for the invitee within a countdown period; and
provide notification to the user that the invitee is in attendance at the live event.

50. The system of claim 43, further comprising one or more storage devices having stored thereon instructions that, upon execution by the one or more computing devices, cause the system at least to:
generate a visual representation of a graphical indicia selectable by the user, wherein the graphical indicia is embedded within the simulated crowd alongside audience icons; and
cause a reward to be granted to the user in response to selection of the graphical indicia within a countdown period.

51. The system of claim 43, further comprising one or more storage devices having stored thereon instructions that, upon execution by the one or more computing devices, cause the system at least to:
send an invitation to an invitee to attend the live event, the invitee a member of a group; and
provide notification to one or more members of the group upon obtaining confirmation of attendance of the invitee.

52. A non-transitory computer-readable storage medium having stored thereon instructions that, upon execution by one or more computing devices, cause the one or more computing devices at least to:
transmit instructions corresponding to an application for providing a simulation of a virtual crowd attending a live event;
maintain a plurality of profiles representative of virtual attendees connected by a network to the simulation of the virtual crowd attending a life event;
select a first subset of the plurality of profiles based at least in part on a random selection of the plurality of profiles;
cause the application to display, on a client device, a first visual representation of the virtual crowd, wherein the first visual representation is generated by the application and comprises a first plurality of audience icons corresponding to the first subset and a first graphical indicia provided by a content provider, the first graphical indicia based at least in part on profiles in the first subset; and
cause the application to display, in response to a selection by a user of the client device, a second visual representation of the virtual crowd, wherein the second visual representation is generated by the application and comprises a second plurality of audience icons corresponding to a second subset of the plurality of profiles, the second subset based at least in part on profiles in the second subset matching a profile characteristic, the second visual representation further comprising a second graphical indicia provided by the content provider, the second graphical indicia based at least in part on profiles of the second subset.

53. The non-transitory computer-readable storage medium of claim 52, comprising further instructions that, upon execution by the one or more computing devices, cause the one or more computing devices to at least:
cause a location indicator to be displayed on an audience icon of a first virtual attendee, the location indicator providing information regarding a physical location of the first virtual attendee.

54. The non-transitory computer-readable storage medium of claim 52, comprising further instructions that, upon execution by the one or more computing devices, cause the one or more computing devices to at least:
form at least one of the first subset based at least in part on a physical location of at least one audience member.

55. The non-transitory computer-readable storage medium of claim 52, comprising further instructions that, upon execution by the one or more computing devices, cause the one or more computing devices to at least:
form the second subset based at least in part on at least one of geographic location, age, gender, high school, college, interest, and social media friendship.

56. The non-transitory computer-readable storage medium of claim 52, comprising further instructions that, upon execution by the one or more computing devices, cause the one or more computing devices to at least:
confirm attendance at the live event of a virtual attendee corresponding to a profile of the plurality of profiles.

57. The non-transitory computer-readable storage medium of claim 52, wherein the first subset is based at least in part on randomizing profile information from the plurality of profiles.

58. The non-transitory computer-readable storage medium of claim 52, wherein the second subset is based at least in part on a random selection of profiles in the plurality of profiles that match the profile characteristic.

59. The non-transitory computer-readable storage medium of claim 52, comprising further instructions that, upon execution by the one or more computing devices, cause the one or more computing devices to at least:
prompt the user to send an invitation to an invitee to attend the live event, wherein the prompting occurs after commencement of the live event and while the live event is proceeding;
obtain confirmation of attendance at the live event for the invitee within a countdown period; and
provide notification to the user that the invitee is in attendance at the live event.

60. The non-transitory computer-readable storage medium of claim 52, comprising further instructions that, upon execution by the one or more computing devices, cause the one or more computing devices to at least:
generate a visual representation of a graphical indicia selectable by the user, wherein the graphical indicia is embedded within the virtual crowd alongside audience icons; and
cause a reward to be granted to the user in response to selection of the graphical indicia within a countdown period.

61. The non-transitory computer-readable storage medium of claim 52, comprising further instructions that, upon execution by the one or more computing devices, cause the one or more computing devices to at least:
send an invitation to an invitee to attend the live event, the invitee a member of a group, wherein profiles corresponding to members of the group each comprise a first profile characteristic; and
provide notification to one or more members of the group upon obtaining confirmation of attendance of the invitee.

62. A computer-implemented method for providing a computer simulation of a live event, the method comprising:
receiving a request from a content provider to provide a client device with access to the computer simulation;
transmitting, in response to the request, an application that performs at least a portion of the computer simulation on the client device, the application comprising instructions that, when executed, forms visual representations of a simulated crowd attending the live event;
storing a plurality of profiles representative of virtual attendees connected by a network to the computer simulation of the live event;
selecting a first subset of the plurality of profiles based at least in part on random selection from the plurality of profiles;
causing the application to display, on the client device, a first visual representation of the simulated crowd, wherein the first visual representation is generated by the application and comprises a first plurality of audience icons corresponding to the first subset and a first graphical indicia provided by the content provider, the first graphical indicia based at least in part on profiles in the first subset; and
causing the application to display, in response to a selection by a user of the client device, a second visual representation of the simulated crowd, wherein the second visual representation is generated by the application and comprises a second plurality of audience icons corresponding to a second subset of the plurality of profiles, the second subset based at least in part on a profile characteristic, the second visual representation further comprising a second graphical indicia provided by the content provider, the second graphical indicia based at least in part on profiles of the second subset.

63. The method of claim 62, further comprising
generating a visual representation of graphical indicia selectable by the user, wherein the graphical indicia is embedded within the simulated crowd alongside audience icons;
tracking a time when the user selects the graphical indicia; and
causing a reward to be granted to the user in response to selection of the graphical indicia.

64. The method of claim 62, further comprising:
prompting the user to send an invitation to an invitee to attend the live event, wherein the prompting occurs after commencement of the live event and while the live event is proceeding.

65. The method of claim 62, further comprising:
transmitting an invitation to an invitee attend the live event; and
obtaining confirmation of attendance of the invitee within a countdown period.
